(19) United States
(12) Patent Application Publication
(10) Pub. No.: US 2011/0010642 A1
(43) Pub. Date: Jan. 13, 2011

(54) Image processing apparatus, display control method, and computer-readable recording medium

(75) Inventor: Kohta Nagai, Tokyo (JP)

Correspondence Address: Harness, Dickey & Pierce P.L.C., P.O. Box 8910, Reston, VA, 20195, US

(73) Assignee: Ricoh Company, Ltd., Tokyo (JP)

(21) Appl. No.: 12/801,911

(22) Filed: Jul. 1, 2010

(30) Foreign Application Priority Data
Jul. 9, 2009 (JP) 2009-163074

(51) Int. Cl. G06F 9/455; G06F 3/048

(52) U.S. Cl. 715/760; 718/1

(57) ABSTRACT

In an image processing apparatus, a standard function and an extension function that uses the standard function operate in a first virtual machine and a second virtual machine different from the first virtual machine, respectively. A second communications interface unit in the second virtual machine generates display control data with the use of a display control command in response to a screen page update request from an application that implements the extension function, the display control data being used for performing display control on the display screen page of the application, and transmits the display control data to the first virtual machine. A first communications interface unit in the first virtual machine sends, to a screen page control module configured to perform screen page control, a request to perform the display control in accordance with the display control data received from the second virtual machine.

### BACKGROUND OF THE INVENTION

1. Field of the Invention

The present invention relates to an image processing apparatus in which plural virtual machines can operate, and more particularly to a technology for controlling a display device of the image processing apparatus.

2. Description of the Related Art

The virtualization technology is known for building a pseudo system in which plural computers appear to be operating in a single physical computer. A pseudo information processing system environment (logic computer) implemented by the virtualization technology is referred to as a virtual machine (VM) (see, for example, International Publication WO01/084303).

In recent years and continuing, the virtualization technology has been applied as an operational environment for image processing apparatuses such as multifunction peripherals (MFP) and personal computers (PC). For example, an operational environment is established in the following manner. That is, two virtual machine environments are operated in a single image processing apparatus. The first virtual machine executes the main functions of image processing. The second virtual machine executes extension functions such as customized functions.

One of the purposes of applying the virtualization technology to image processing apparatuses is to secure the robustness of main functions relevant to image processing.

The software for implementing the extension functions may include software that has been developed by other companies such as third party vendors. Unlike the main functions, the software for the extension functions is likely to cause failures, such as a failure in collaborating with other software. When such a failure occurs due to software developed by another company, the manufacturer of the image processing apparatus may not be able to fix the failure. Therefore, it may be time consuming to fix the failure. For this reason, there is demand for an image processing apparatus having an operational environment in which the main functions and the extension functions are operated in different virtual machines, so that even when a failure occurs in an extension function, the processes of the main functions are unaffected by such a failure.

Incidentally, recent image processing apparatuses can display a wide variety of information items on a large display panel. For example, Japanese Laid-Open Patent Application No. 2008-131388 discloses an image processing apparatus in which browser is used for controlling the operation of displaying information (display control).

However, in conventional image processing apparatuses, in order to display information on a display screen, an increased amount of communication data is exchanged between the virtual machines, and the frequency of communication increases between the virtual machines. Consequently, the process of displaying the information on the display screen is delayed, which leads to degraded usability for the user.

In an image processing apparatus having plural virtual machines, communications are performed between a first virtual machine and a second virtual machine such that the functions are implemented as if they are operating in a single virtual machine. In such an environment of the image processing apparatus, when the operation of displaying an updated screen page is executed, data including the updated information is exchanged between the virtual machines. The updated information may amount to a large volume. As a result, when the operation of displaying information is implemented in the image processing apparatus, an increased amount of communication data is exchanged between the virtual machines, and the frequency of communication increases between the virtual machines.

### SUMMARY OF THE INVENTION

The present invention provides an image processing apparatus, a display control method, and a computer-readable recording medium, in which one or more of the above-described disadvantages are eliminated.

A preferred embodiment of the present invention provides an image processing apparatus, a display control method, and a computer-readable recording medium, with which information can be displayed on a display screen at high speed in a system with plural virtual machines.

According to an aspect of the present invention, there is provided an image processing apparatus including a first virtual machine in which a standard function of the image processing apparatus is operated; a second virtual machine in which an extension function that uses the standard function is operated, the second virtual machine being different from the first virtual machine; plural operation modules configured to implement display control on a display screen page as the standard function; a first communications interface unit configured to operate in the first virtual machine; and a second communications interface unit configured to operate in the second virtual machine, wherein the first communications interface unit and the second communications interface unit perform inter-virtual machine communication that is common to the plural operation modules, the second communications interface unit includes a generating unit configured to generate display control data with the use of a display control command in response to a screen page update request from an application that implements the extension function, the display control data being used for performing the display control on the display screen page of the application, and a data transmitting unit configured to transmit the display control data generated by the generating unit to the first virtual machine in which the standard function is operated, and the first communications interface unit includes a data receiving unit configured to receive the display control data from the second virtual machine, and a requesting unit configured to send, to a screen page control module configured to perform screen page control included among the plural operation modules, a request to perform the display control in accordance with the display control data received by the data receiving unit.

According to an aspect of the present invention, there is provided a display control method performed in an image processing apparatus including a first virtual machine in which a standard function of the image processing apparatus is operated, a second virtual machine in which an extension function that uses the standard function is operated, the second virtual machine being different from the first virtual machine, plural operation modules configured to implement display control on a display screen page as the standard function, a first communications interface unit configured to operate in the first virtual machine, and a second communications interface unit configured to operate in the second virtual machine, wherein the first communications interface unit and the second communications interface unit perform inter-virtual machine communication that is common to the plural operation modules, the display control method including generating step performed by the second communications interface unit to generate display control data with the use of a display control command in response to a screen page update request from an application that implements the extension function, the display control data being used for performing the display control on the display screen page of the application; a data transmitting step performed by the second communications interface unit to transmit the display control data generated by the generating unit to the first virtual machine in which the standard function is operated; a data receiving step performed by the first communications interface unit to receive the display control data from the second virtual machine; and a requesting step performed by the first communications interface unit to send, to a screen page control module configured to perform screen page control included among the plural operation modules, a request to perform the display control in accordance with the display control data received by the data receiving unit.

According to an aspect of the present invention, there is provided a computer-readable recording medium having recorded therein instructions for causing a computer to function as an image processing apparatus including a first virtual machine in which a standard function of the image processing apparatus is operated, a second virtual machine in which an extension function that uses the standard function is operated, the second virtual machine being different from the first virtual machine, plural operation modules configured to implement display control on a display screen page as the standard function, a first communications interface unit configured to operate in the first virtual machine, and a second communications interface unit configured to operate in the second virtual machine, wherein the first communications interface unit and the second communications interface unit perform inter-virtual machine communication that is common to the plural operation modules, the instructions causing the image processing apparatus to execute a generating step performed by the second communications interface unit to generate display control data with the use of a display control command in response to a screen page update request from an application that implements the extension function, the display control data being used for performing the display control on the display screen page of the application; a data transmitting step performed by the second communications interface unit to transmit the display control data generated by the generating unit to the first virtual machine in which the standard function is operated; a data receiving step performed by the first communications interface unit to receive the display control data from the second virtual machine; and a requesting step performed by the first communications interface unit to send, to a screen page control module configured to perform screen page control included among the plural operation modules, a request to perform the display control in accordance with the display control data received by the data receiving unit.

According to one embodiment of the present invention, an image processing apparatus, a display control method, and a computer-readable recording medium are provided, with which the amount of data communicated between virtual machines can be reduced while performing display control of a display screen page, and a screen page can be displayed at high speed in a system with plural virtual machines.

### BRIEF DESCRIPTION OF THE DRAWINGS

Other objects, features and advantages of the present invention will become more apparent from the following detailed description when read in conjunction with the accompanying drawings, in which:

FIG. 1 illustrates a hardware configuration of an image processing apparatus according to a first embodiment of the present invention;

FIG. 2 illustrates a system configuration with plural virtual machines, according to the first embodiment of the present invention;

FIG. 3 illustrates a software configuration of the system with plural virtual machines, according to the first embodiment of the present invention;

FIG. 4 illustrates a functional configuration of a subset module according to the first embodiment of the present invention;

FIG. 5 illustrates an example of hierarchization of display elements according to the first embodiment of the present invention;

FIG. 6 illustrates an example of data used for display control according to the first embodiment of the present invention;

FIG. 7 is a sequence diagram of processing procedures (process 1) for performing display control according to the first embodiment of the present invention;

FIG. 8 is a sequence diagram of processing procedures (process 2) for performing display control according to the first embodiment of the present invention;

FIG. 9 illustrates a software configuration of a system with plural virtual machines, according to a second embodiment of the present invention;

FIG. 10 illustrates the state transition of a button image according to the second embodiment of the present invention;

FIG. 11 is a sequence diagram of processing procedures (part 1) for implementing display control according to the second embodiment of the present invention;

FIG. 12 illustrates an example of a data structure for display control according to the second embodiment of the present invention;

FIGS. 13A through 13C illustrate examples of data (part 1) of display element information according to the second embodiment of the present invention;

FIGS. 14A and 14B illustrate examples of data (part 2) of display element information according to the second embodiment of the present invention;

FIGS. 15A through 15C illustrate examples of data (part 3) of display element information according to the second embodiment of the present invention;

FIG. 16 is a sequence diagram of processing procedures (process 2) for implementing display control according to the second embodiment of the present invention; and

FIG. 17 illustrates a software configuration of a system with plural virtual machines, according to a modification of an embodiment of the present invention.

### DETAILED DESCRIPTION OF THE PREFERRED EMBODIMENTS

A description is given, with reference to the accompanying drawings, of embodiments of the present invention.

### First Embodiment

<Hardware Configuration>

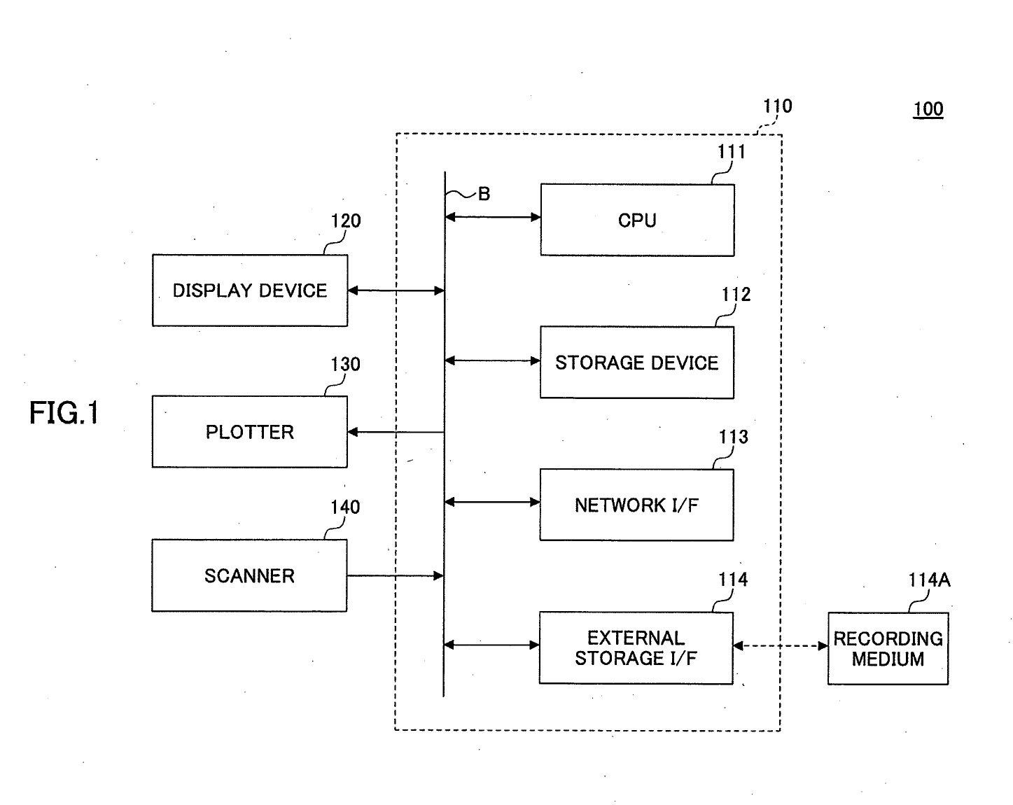

FIG. 1 illustrates a hardware configuration of an image processing apparatus 100 according to a first embodiment of the present invention.

As shown in FIG. 1, the image processing apparatus 100 includes a controller 110, a display device 120, a plotter 130, and a scanner 140, which are connected to each other via a bus B.

The display device 120 has a display unit and an input unit such as a touch panel. The display device 120 is for providing the user with various kinds of information such as device information, and for receiving various user-input operations such as operational settings and operational instructions. The plotter 130 includes an image forming unit and forms images (output images) on a sheet. The output images may be formed by an electrophotographic method, an inkjet method, etc. The scanner 140 optically scans an original document, and generates a scanned image.

The controller 110 includes a CPU (Central Processing Unit) 111, a storage device 112, a network I/F 113, and an external storage I/F 114, which are connected to each other by the bus B.

The CPU 111 executes programs to implement various functions and to control the overall image processing apparatus 100. The storage device 112 stores the aforementioned programs and various kinds of data (for example, image data). For example, the storage device 112 may be a RAM (Random Access Memory) that is a volatile memory, a ROM (Read Only Memory) that is a nonvolatile memory, and a HDD (Hard Disk Drive) having a large capacity storage area. The RAM functions as a work area (storage area into which programs and data are temporarily loaded) of the CPU 111. The ROM and HDD are used for storing programs and various kinds of data. Accordingly, in the image processing apparatus 100, the CPU 111 loads the programs into the RAM from the ROM, and executes the programs.

The network I/F 113 is an interface for connecting the image processing apparatus 100 to a predetermined data transmission line such as a network. The external storage I/F 114 is an interface for connecting a recording medium 114A, which is an external storage device, to the image processing apparatus 100. For example, the external storage device may be an SD memory card or a USB (Universal Serial Bus) memory. Accordingly, the image processing apparatus 100 can read the programs and data stored in the recording medium 114A via the external storage I/F 114.

According to the above-described hardware configuration of the image processing apparatus 100, the CPU 111 may execute a program that has been loaded into the RAM from the HDD to operate one or more virtual machine environments.

<System and Software Configuration>

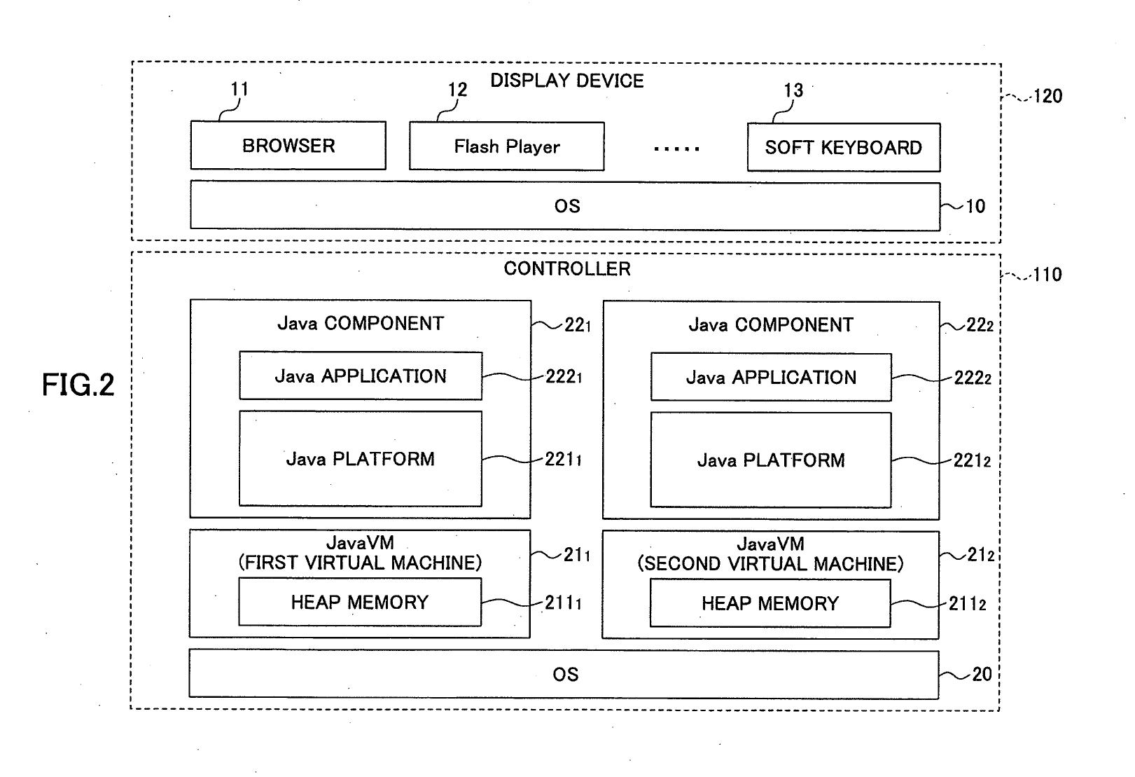

FIG. 2 illustrates a system configuration with plural virtual machines, according to the first embodiment of the present invention.

As shown in FIG. 2, in the image processing apparatus 100, the display device 120 and the controller 110 include different software items. In the hardware environment according to the present embodiment, it is assumed that the display device 120 and the controller 110 have separate control units (CPUs).

(Display Device)

The display device 120 includes applications relevant to screen display, such as a browser 11, a Flash Player 12, and a soft keyboard 13, which are operated on an OS (Operating System) 10. The OS 10 is embedded basic software such as Linux (registered trademark, hereafter omitted). The browser 11 is software for browsing Web contents described in HTML (HyperText Markup Language). The Flash Player 12 (registered trademark, hereafter omitted) is a browser plug-in that corresponds to a cross-platform with which Web contents can be provided. The soft keyboard 13 is GUI (Graphical User Interface) software for supporting the operation of inputting characters with a display screen.

The display device 120 can provide information to the user and display a GUI, with the above-described software configuration.

(Controller)

The system configuration illustrated in FIG. 2 includes two virtual machines operating in the controller 110 of the image processing apparatus 100 (a single physical computer).

As shown in FIG. 2, the virtual machine environment is formed by operating programs for implementing the virtual machine environment on an OS 20. In the present embodiment, the virtual machine environment is formed by operating a Java (registered trademark, hereafter omitted) VM (Virtual Machine) 21. The OS 20 is embedded basic software, similar to the OS 10.

Plural virtual machine environments can be implemented by operating plural Java VMs 21 on the OS 20. In the present embodiment, a Java VM 21₁ and a Java VM 21₂ (two Java VMs 21),are operated to implement a first virtual machine environment and a second virtual machine environment (two virtual machine environments), respectively. In the following descriptions, the Java VM 21₁ and the Java VM 21₂ are referred to as a first virtual machine 21₁ and a second virtual machine 21₂, respectively. The first virtual machine 21₁ and the second virtual machine 21₂ may be referred to as a virtual machine 21 (without distinguishing whether it is a first or second virtual machine). Similarly, software (for example, programs and data) and storage areas operated in the respective virtual machines 21 may also be collectively referred to with common reference numerals (a subscript 1 and a subscript 2 accompanying the reference numerals are relative to the first virtual machine 21₁ and the second virtual machine 21₂, respectively).

The virtual machine 21 includes a heap memory 211 for operating a Java component 22 provided on the virtual machine 21. The heap-memory 211 is a memory area that can be freely used by an application operating on the virtual machine 21. As described above, in this system with plural virtual machines 21, each virtual machine 21 has a separate heap memory 211. Therefore, even if a failure occurs and a process stops in one of the virtual machines 21, the systems of the other virtual machine 21 will be unaffected.

The Java component 22 that is operated on the virtual machine 21 includes plural Java programs for implementing the functions of the platform and application, i.e., a Java platform 221 and a Java application 222, as shown in FIG. 2. The Java platform 221 operates as a standard function of the system (operational environment) implemented by the virtual machine 21. The Java application 222 is a function for using the basic function to execute an operation desired by the user (a function provided by the user in the virtual machine environment, hereinafter, “user-provided function”). The Java application 222 may be installed or uninstalled according to the function configuration.

As described above, an environment with plural virtual machines 21 is built into the image processing apparatus 100 according to the present embodiment.

Next, a detailed description is given of the software configuration in the above system.

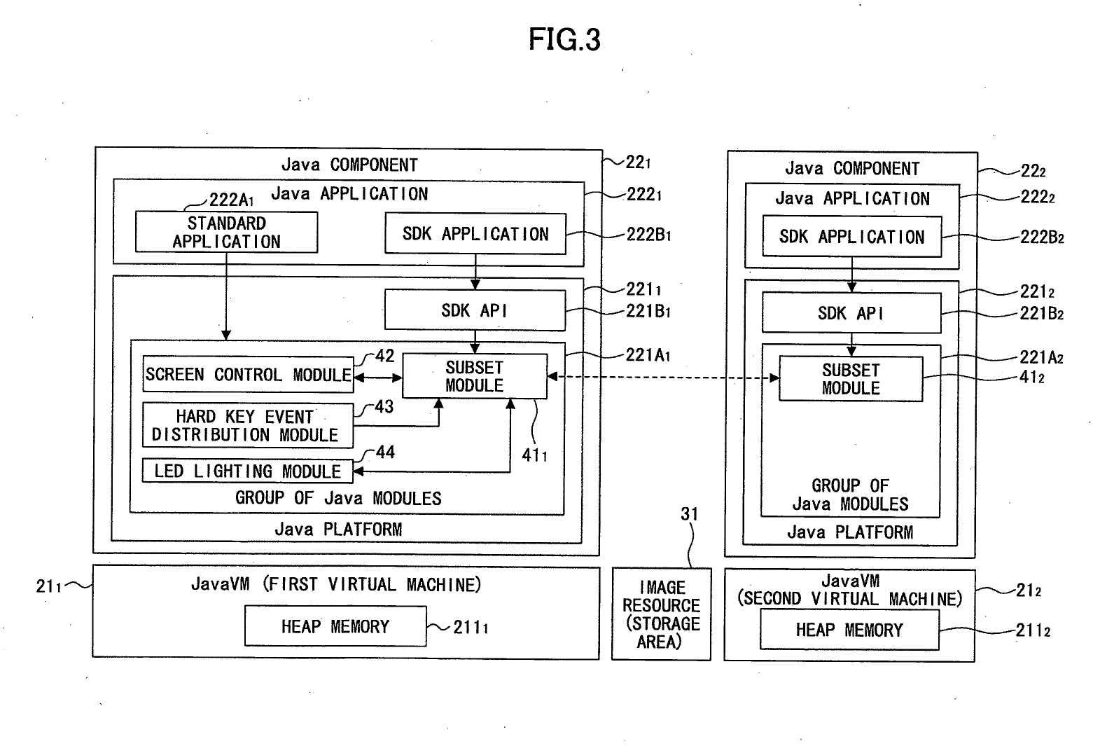

FIG. 3 illustrates a software configuration of the system with plural virtual machines 21, according to the first embodiment of the present invention.

For example, assuming that the image processing apparatus 100 of the above-described system is a MFP (Multifunction Peripheral), the image processing apparatus 100 may have the following system.

In the first virtual machine 21₁, standard functions such as a printer, a scanner, and a fax (facsimile) are operated. The Java application 222₁ of the Java component 22₁ operating on the first virtual machine 21₁ includes a standard application 222A₁ and an SDK (Software Development Kit) application 222B₁. The Java platform 221₁ includes a group of Java modules (group of operation modules) 221A₁ and an SDK API (Application Program Interface) 221B₁.

The standard application 222A₁ is software for implementing a user-provided function using standard functions installed in the MFP. The standard application 222A₁ uses, as a standard function, an operation module in the group of Java modules 221A₁ of the platform. For example, the group of Java modules 221A₁ includes operation modules (not shown) for implementing standard functions such as a printer, a scanner, and a fax machine. Accordingly, the standard application 222A₁ implements a copy function (copy application) with the use of the operation modules of a printer and a scanner in the group of Java modules 221A₁.

The group of Java modules 221A₁ includes operation modules for implementing the standard functions relevant to display control. Examples of such operation modules are a screen control module 42, a hard key event distribution module 43, and an LED (Light Emitting Diode) lighting module 44. The screen control module 42 is an operation module for implementing a screen control function such as generating and updating screen pages. The hard key event distribution module 43 is an operation module for implementing a distribution function of an event (for example, an event of pressing the start key) detected from hard keys such as a numeric keypad (not shown) of the image processing apparatus 100. A distribution function is for reporting the detected event to various functions that are operated according to the corresponding event. The LED lighting module 44 is an operation module for implementing the function of controlling lighting of LEDs provided in the image processing apparatus 100.

As described above, various functions relevant to display control are operated on the first virtual machine 21₁ of the image processing apparatus 100. Examples of such functions are generating screen pages, updating screen pages, distributing hard key events, and controlling lighting of LEDs.

The SDK application 222B₁ is developed with the use of the SDK API 221B₁ that is an assembly of commands and functions that can be used when developing software. The SDK application 222B₁ is software for implementing functions that uniquely correspond to each user (customized functions). The SDK application 222B₁ uses an operation module of the group of Java modules 221A₁ included in the platform, via the SDK API 221B₁. For example, the SDK application 222B₁ implements a usage authentication function for printing (secure print application), by using the printer module of the group of Java modules 221A₁ via the SDK API 221B₁ in combination with an authentication module that is an extension function.

Meanwhile, in the second virtual machine 21₂, extension functions (for example, functions provided by third party vendors) for using standard functions are operated.

The Java application 222₂, which is included in the Java component 22₂ that operates on the second virtual machine 21₂, includes an SDK application 222B₂. The Java platform 221₂, which is included in the Java component 22₂ that operates on the second virtual machine 21₂, includes an SDK API 221B₂.

As described above, the SDK application 222B₂ can be individually developed by using the SDK API 221B₂ of the platform. The SDK application 222B₂ for implementing extension functions is software that has been developed and provided by a third party vendor. With regard to the software that has been developed by the third party vendor, it is not known how it has been designed and programmed, what kind of processes it has undergone to be tested, or what kind of process it has undergone before being provided. Therefore, unexpected errors (failures) such as memory leakage may occur during execution.

In such a case, if the SDK application 222B₂ (extension function) is operated on the same virtual machine 21 (first virtual machine 21₁) as the standard application 222A₁ (standard function), the entire system may stop (system down) due to a failure of the SDK application 222B₂. Thus, in the present embodiment, the standard functions and the extension functions installed in the MFP are operated on different virtual machines 21. Accordingly, even if a failure occurs in the extension function, the MFP may continue to provide the user with services of the standard functions.

However, with such a system configuration, the SDK application 222B₂ operating on the second virtual machine 21₂ needs to perform data communications (inter-virtual machine communications) with the operation module of the group of Java modules 221A₁ on the first virtual machine 21₁. This is because the SDK application 222B₂ operating on the second virtual machine 21₂ implements its function (extension function) by using the operation module (module for implementing a standard function) operating on the first virtual machine 21₁.

One method of responding to inter-virtual machine communications is to operate a communications module corresponding to each operation module on the second virtual machine 21₂ (method of responding in units of operation modules). However, numerous communication modules may be needed if the system is large-scale and there are numerous operation modules collaborating with each other in the system. In this case, it is unrealistic to execute the above method. Even if numerous communication modules can be provided for the operation modules, the management/maintenance of the system may involve complex operations in the event of a failure. Furthermore, numerous communication modules need to be operated on the virtual machine 21, which leads to needless consumption of resources.

Therefore, in the present embodiment, each virtual machine is provided with an interface unit for the whole system. The interface units have data communications functions (inter-virtual machine communications functions) performed between the virtual machines 21. The interface unit is a subset module (communications interface unit) 41 of the group of Java modules 221A of the Java platform 221 operating on each virtual machine 21. One subset module 41 operates on each virtual machine 21.

In response to a request to execute a function from the SDK application 222B, the subset module 41 sends a request for executing processes to the operation modules that operate in coordination with each other for implementing the requested function. Furthermore, the subset module 41 exchanges function execution requests with another virtual machine to control execution of operation modules operating on the other virtual machine.

As described above, the subset module 41 functions as a common communications interface for plural operation modules.

Among the display control processes relevant to the SDK application 222B₂ that operates on the second virtual machine 21₂, there are processes that need to be transferred from the second virtual machine 21₂ to the first virtual machine 21₁.

Processes that need to be transferred between the virtual machines include generating screen pages, updating screen pages, distributing hard key events, and controlling lighting of LEDs. As described above, these processes are standard functions relevant to display control, and are operated on the first virtual machine 21₁. Therefore, as for functions of generating screen pages, updating screen pages, and controlling lighting of LEDs, the second virtual machine 21₂ needs to send a control request to the first virtual machine 21₁. As for the function of distributing a hard key event, the event needs to be distributed from the first virtual machine 21₁ to the second virtual machine 21₂.

Specifically, the display control processes are transferred as follows. For example, the SDK application 222B₂ operating on the second virtual machine 21₂ indicates an operation of requesting an update of the application screen page. The SDK application 222B₂ sends a request to update the screen page to the subset module 41₁ of the first virtual machine 21₁ via the subset module 41₂ of the second virtual machine 21₂. The subset module 41₁ of the first virtual machine 21₁ requests the specified screen control module 42 to execute a process based on the screen page update request that has been received.

As described above, in the image processing apparatus 100, inter-virtual machine communications are performed via the subset modules 41 that are communications interfaces, so that a display control process is executed from the SDK application 222B₂ operating on the second virtual machine 21₂.

The only Java application 222 operating on the second virtual machine 21₂ is the SDK application 222B₂, and therefore the subset module 41₂ of the second virtual machine 21₂ has an instance (actual value) of the SDK API 221B₂ and unique data of the SDK application 222B₂.

Furthermore, as shown in FIG. 3, the image processing apparatus 100 has an image resource 31 for holding various image data items relevant to displaying screen pages. The image resource 31 is a storage area for image data that is common to the first virtual machine 21₁ and the second virtual machine ²1₂.

In a GUI provided for the user, image data items are typically used as display elements such as windows and buttons. For example, it is assumed that image data of a display element relevant to the SDK application 222B₂ operating on the second virtual machine 21₂ is held on the second virtual machine 21₂ (in a storage area of the second virtual machine 21₂).

In such a configuration, when the display control process is performed via the subset modules 41, the image data necessary for forming the display screen page (a screen page to be displayed) is sent from the second virtual machine 21₂ to the first virtual machine 21₁. This leads to an increase in the amount of data communicated between the virtual machines and a delay in displaying images (delay in the processing time), thereby degrading the usability for the user.

Thus, the present embodiment includes the image resource 31 for loading and caching the image data to be used as display elements, to increase the speed of displaying a screen page. That is to say, in the image processing apparatus 100, image data is not exchanged between the virtual machines when performing the display control process, so that the process of displaying the screen page is prevented from being delayed.

The image resource 31 is a predetermined storage area in the storage device 112 (for example, an HDD) provided in the image processing apparatus 100. The image data is loaded and saved in the image resource 31 by each application name and product number, every time the SDK application 222B is installed.

Accordingly, in the image processing apparatus 100, the screen control module 42 operating on the first virtual machine 21₁ accesses the image resource 31, and displays an application screen page with the use of the image data acquired from the image resource 31, based on application identification information such as an application name or a product number for identifying the SDK application 222B.

<Display Control Function>

A description is given of a display control function of the present embodiment.

In the image processing apparatus 100 according to the present embodiment, the second virtual machine 21₂ acquires attribute information of display elements that form the display screen page according to a request to update the screen page, and generates display control data with the use of a unique command for display control (hereinafter, display control command) based on the acquired attribute information. The image processing apparatus 100 sends the generated display control data to the first virtual machine 21₁ on which the screen control module 42 that controls the display screen page is operating. As a result, the image processing apparatus 100 executes the screen control module 42 and performs display control according to the received data, on the first virtual machine 21₁. The image processing apparatus 100 has the above-described display control function. The display control function according to the present embodiment is implemented as the subset module 41 operates on the virtual machine 21.

As described above, the display control processes transferred from the second virtual machine 21₂ to the first virtual machine 21₁ include generating screen pages, updating screen pages, distributing hard key events, and controlling lighting of LEDs.

Among these processes, in the processes of distributing hard key events and controlling lighting of LEDs, the only information that is sent from the second virtual machine 21₂ to the first virtual machine 21₁ is hard key information that is distributed and LED information specified for requesting to light an LED. Accordingly, the amount of data transmission is small. Furthermore, when generating a screen page, the only information that is sent from the second virtual machine 21₂ to the first virtual machine 21₁ is application identification information used for requesting to generate the screen page. Accordingly, the amount of data transmission is small.

However, in the process of updating a screen page (for example, a process of changing the entire display screen page), a large amount of display element information is sent from the second virtual machine 21₂ to the first virtual machine 21₁. An example of inter-virtual machine communications is RMI (Remote Method Invocation API) communications. However, in RMI communications, instances (actual values) of Java are often exchanged, including data that is unnecessary for screen page control. Furthermore, the process of updating a screen page is executed more frequently than the process of generating a screen page, the process of distributing hard key events, and the process of controlling lighting of LEDs.

Accordingly, in inter-virtual machine communications for the process of updating a screen page, a large amount of data is usually transmitted. This leads to a delay in the process of displaying the screen page (delay in the processing time).

Thus, the image processing apparatus 100 according to the present embodiment generates display control data with the use of a unique command for display control, for the purpose of reducing the data transmission amount when updating the screen page. The generated display control data is transmitted from the second virtual machine 21₂ to the first virtual machine 21₁ to request display control.

Accordingly, in the image processing apparatus 100, a reduced amount of data is transmitted between virtual machines when implementing display control. As a result, information provided for the user and a GUI can be displayed at high speed (the process of displaying a screen page can be accelerated).

A description is given of a configuration and an operation of the display control function. In the following, function units of the subset module 41 (function units for implementing the display control function) having the same name may be collectively referred to with the same name and same reference numeral.

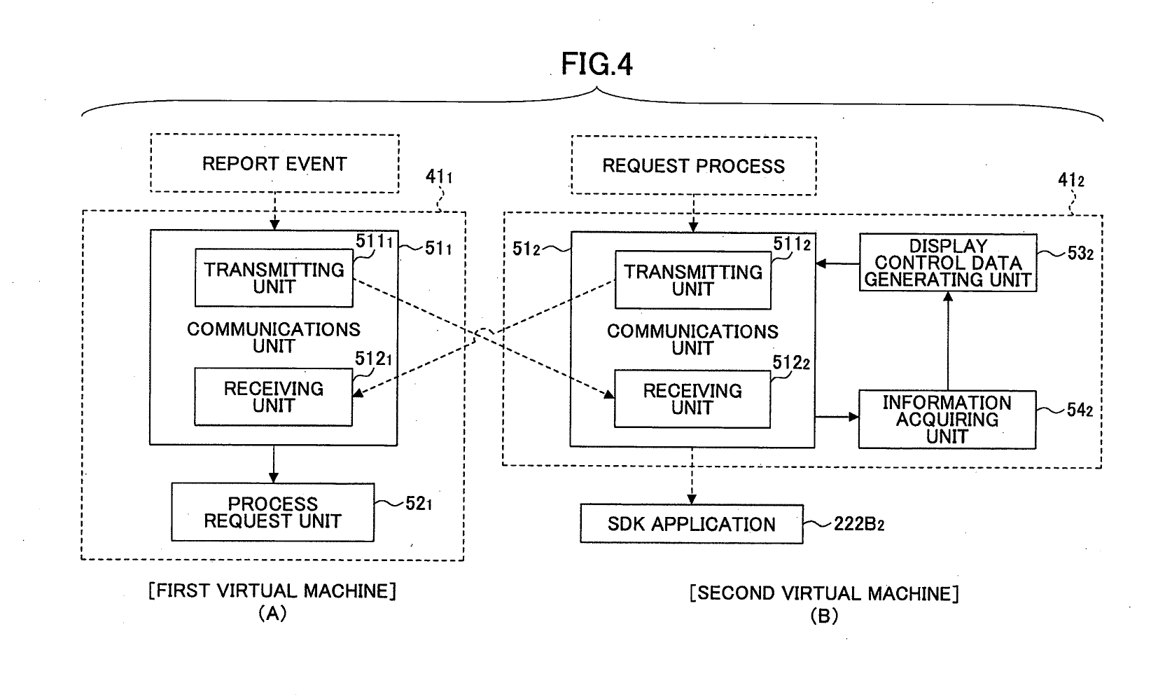

FIG. 4 illustrates a functional configuration of the subset module 41 according to the present embodiment. (A) indicates the functional configuration of the subset module 41₁ operating on 10 the first virtual machine 21₁, and (B) indicates the functional configuration of the subset module 41₂ operating on the second virtual machine 21₂.

As shown in FIG. 4, the subset modules 41 of the first virtual machine 21₁ and the second virtual machine 21₂ have the same type of communications unit 51. The communications unit 51 includes a transmitting unit 511 for transmitting data to the other virtual machine and a receiving unit 512 for receiving data from the other virtual machine.

For example, when an event report that a hard key has been pressed is received from the hard key event distribution module 43 operating on the first virtual machine 21₁, the transmitting unit 511₁ of the first virtual machine 21₁ transmits hard key information based on the reported event to the second virtual machine 21₂. The transmitted hard key information is received by the receiving unit 512₂ of the second virtual machine 21₂. Accordingly, in the image processing apparatus 100, a hard key event distribution process is transferred from the first virtual machine 21₁ to the second virtual machine 21₂.

Meanwhile, when a request to light an LED is received from the SDK application 222B₂ of the second virtual machine 21₂, the transmitting unit 511₂ of the second virtual machine 21₂ transmits specified LED information to the first virtual machine 21₁ based on the request. The transmitted specified LED information is received by the receiving unit 512₁ of the first virtual machine 21₁. Accordingly, in the image processing apparatus 100, an LED lighting process is transferred from the second virtual machine 21₂ to the first virtual machine 21₁.

When a request to generate an application screen page is received from the SDK application 222B₂ of the second virtual machine 21₂, the transmitting unit 511₂ transmits application identification information to the first virtual machine 21₁ based on the request. The transmitted application identification information is received by the receiving unit 512₁ of the first virtual machine 21₁. Accordingly, in the image processing apparatus 100, a screen page generating process is transferred from the second virtual machine 21₂ to the first virtual machine 21₁.

When a display control data generating unit 53₂ (described below) generates display control data instructing to update a screen page in accordance with a request to update the application screen page, the transmitting unit 511₂ transmits the generated display control data to the first virtual machine 21₁. The transmitted display control data is received by the receiving unit 512₁ of the first virtual machine 21₁. Accordingly, in the image processing apparatus 100, a screen page updating process is transferred from the second virtual machine 21₂ to the first virtual machine 21₁.

As shown in FIG. 4(A), the subset module 41₁ operating on the first virtual machine 21₁ includes a process request unit 52₁.

The process request unit 52₁ is a function unit for requesting an operation module operating on the first virtual machine 21₁ to execute a process. The process request unit 52₁ makes a request to execute a process according to a process request received at the receiving unit 512₁.

For example, when the receiving unit 512₁ receives a request to light an LED, the process request unit 52₁ requests the LED lighting module 44 operating on the first virtual machine 21₁ to execute an LED lighting process based on the specified LED information accompanying the request. When a request to generate an application screen page is received at the receiving unit 512₁, the process request unit 52₁ requests the screen control module 42 operating on the first virtual machine 21₁ to execute a screen page generating process based on application identification information accompanying the request. When a request to update an application screen page is received at the receiving unit 512₁, the process request unit 52₁ requests the screen control module 42 operating on the first virtual machine 21₁ to execute a screen page update process based on the display control data accompanying the request.

Next, as shown in FIG. 4(B), the subset module 41₂ operating on the second virtual machine 21₂ includes the display control data generating unit 53₂ and an information acquiring unit 54₂.

The display control data generating unit 53₂ is a function unit for generating display control data with the use of a unique command for display control, for the purpose of reducing the data transmission amount. The display control data generating unit 53₂ generates display control data based on attribute information of display elements used for forming the application screen page corresponding to the screen page update request.

The information acquiring unit 54₂ is a function unit for acquiring, from the SDK application 222B₂, attribute information of display elements used for forming the application screen page. The attribute information of a display element includes layout positions (layout coordinates), appearance (for example, color and size), and operation (for example, click action).

The SDK application 222B₂ needs to update an application screen page when an event report is received. Accordingly, the communications unit 51₂ determines whether it is necessary to update the application screen page of the SDK application 222B₂ according to the display control process transferred from the first virtual machine 21₁. In the present embodiment, when a hard key event distribution process is transferred, it is determined whether the application screen page is to be updated based on hard key information. The determination whether the application screen page is to be updated may be made based on information other than the hard key information, such as operation event information including various input operation events that are input via the browser 11 or the soft keyboard 13.

When the communications unit 51₂ determines that the application screen page is to be updated, the communications unit 51₂ requests the information acquiring unit 54₂ to acquire attribute information relevant to display elements. The information acquiring unit 54₂ passes the acquired attribute information to the display control data generating unit 53₂, to request the display control data generating unit 53₂ to generate display control data.

The following describes the display control data generated by the display control data generating unit 53₂.

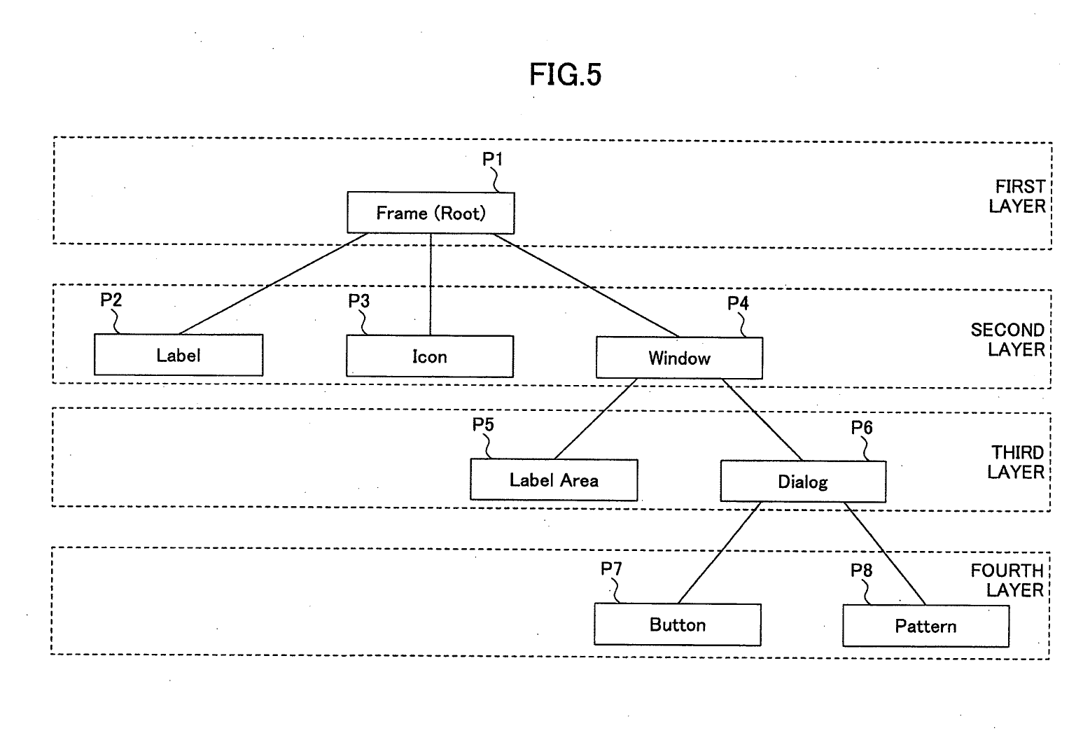

FIG. 5 illustrates an example of a hierarchy of display elements P according to the present embodiment.

A description is given of the configuration of display elements P forming the display screen page. The SDK application 222B forms the display screen page with the use of the SDK API 221B. As shown in FIG. 5, the formed display screen page includes plural types of display elements P1 through P8. Thus, the SDK application 222B forms an application screen page by sequentially superposing these display elements P from the back side toward the forefront side, according to a predetermined layout. The display elements P according to the present embodiment have a hierarchical structure according to characteristics of the operation of forming a display screen page.

FIG. 5 illustrates a hierarchical structure in which a first layer includes a display element P located on the back side and a fourth layer includes display elements P located on the forefront side. For example, in this hierarchical structure, a Label P2, an Icon P3, and a Window P4 are laid out on a Frame P1. Furthermore, a Label Area P5 and a Dialog P6 are laid out on the Window P4. Furthermore, a Button P7 and a Pattern P8 are laid out on the Dialog P6. Accordingly, in the hierarchical structure, one or more child display elements P may be laid out on a parent display element P.

As described above, in the hierarchical structure according to the present embodiment, display elements P forming the display screen page are associated with each other.

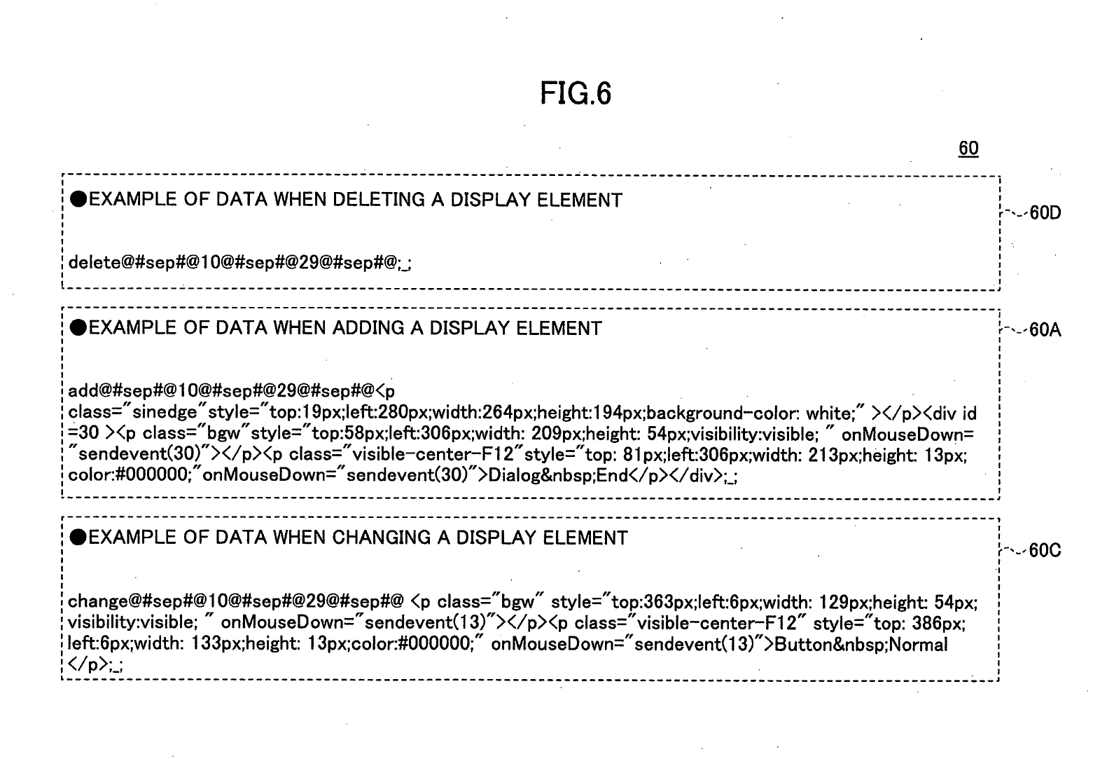

FIG. 6 illustrates an example of data used for display control according to the present embodiment.

The display control data generating unit 53₂ generates display control data 60 as illustrated in FIG. 6. The display control data 60 includes display control commands for instructing display control such as “delete”, “add”, and “change”, and display element data for the display elements P that are the targets of control. In the display element data, predetermined separators “@#” and “#@” are used to specify a display element P corresponding to the parent in the hierarchical structure, and one or more display elements P corresponding to children, in the hierarchical structure.

The following are examples of data for controlling “delete”, “add”, and “change” of the display elements P when updating the screen page.
When deleting a display element delete @#sep#@[identifier of parent display element]@#sep#@[identifier of display element to be deleted]
When adding a display element add @#sep#@[identifier of parent display element]@#sep@#[identifier of display element to be added]@#sep@#]contents of,display element to be added]
When changing a display element change @#sep#@[ identifier of parent display element]@#sep#@[identifier of display element to be changed]@#sep#@[contents of display element to be changed]

The above described identifier of a display element is identification information (ID) with which each display element P can be uniquely identified. An identifier is assigned to a display element when the SDK application 222B₂ forms the application screen page.

The contents of the display element to be added or changed include detailed information relevant to the layout position, the appearance, and the operation of the display element P to be added or changed, as shown in the display control data for adding/changing display elements illustrated in FIG. 6.

As described above, in the present embodiment, the amount of data required for display control included in the display control data 60 is minimized, and therefore the amount of data communicated between virtual machines when updating a screen page can be reduced.

Furthermore, in the present embodiment, the display elements P that are control targets are specified according to the parent-child relationship in the hierarchical structure. Accordingly, the following display control process can be performed.

For example, when deleting a display element P, plural display elements P (child display elements), which are laid out on the display element P to be deleted, do not have to be deleted one by one. Only the display element P that is the target to be deleted needs to be specified in the display control data 60. Accordingly, all of the child display elements P can be deleted due to the parent-child relationship.

Furthermore, with the display control data 60, plural requests for updating the screen page can be made by using predetermined separators to divide the display control commands.

The following is an example of data for controlling “delete” and “add” of the display elements P when updating the screen page.
When adding a new display element after deleting a display element delete @#sep#@ . . . @#sep#@; . . . ; add @#sep#@ . . . @#sep#@ . . . .

As described above, in the present embodiment, plural display control process requests relevant to the process of updating a screen page may, be made together at once, and therefore the display control data 60 may include plural display control commands.

The display control data generating unit 53₂ determines the display control command according to the contents of the operation for updating a screen page. Next, the display control data generating unit 53₂ uses predetermined separators to specify display element identifiers for display elements P that are control targets and a display element P corresponding to the parent. When “add” or “change” is specified as the display control operation for updating a screen page, the display control data generating unit 53₂ adds the contents (detailed information) of the display element that is the control target to the display control data 60, based on attribute information of the display element P acquired from the SDK application 222B₂ by the information acquiring unit 54₂. The display control data generating unit 53₂ generates the display control data 60 having the above described structure.

As described above, the display control function according to the present embodiment is implemented as the function units operate in collaboration with each other.

Next, detailed operations of the display control function (collaborated operations of function units) are described with reference to a sequence diagram of processing procedures.

The display control function, which is implemented as a display control program installed in the image processing apparatus 100, is loaded into the RAM from the storage (for example, the ROM), and the following processes are executed. The display control process is described in the order of a process (process 1) for generating an application screen page of the SDK application 222B₂ operating on the second virtual machine 21₂, and a process (process 2) for updating the application screen page of the SDK application 222B₂ when a button is pressed.

(Process 1—First Embodiment)

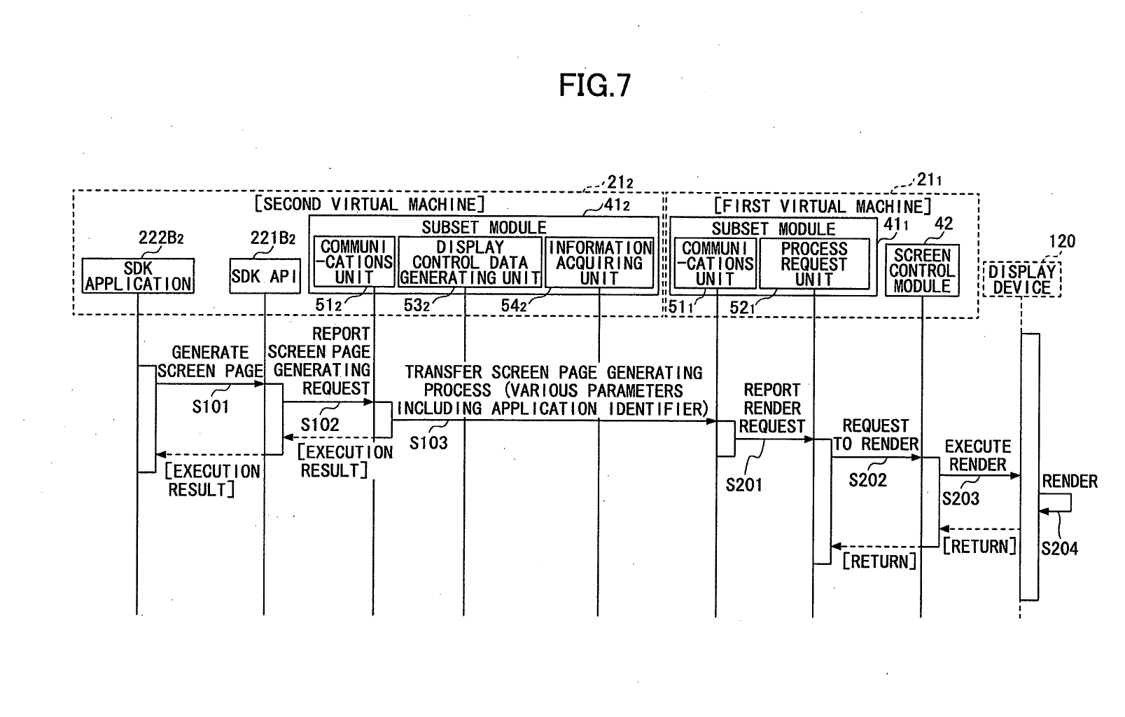

FIG. 7 is a sequence diagram of processing procedures (process 1) for performing display control according to the present embodiment.

As shown in FIG. 7, in the image processing apparatus 100, the following display control process is executed to generate an application screen page of the SDK application 222B₂ operating on the second virtual machine 21₂.

The SDK application 222B₂ operating on the second virtual machine 21₂ generates an application screen page with the use of the SDK API 221B₂ (step S101).

The SDK API 221B₂ sends an application screen page generating request to the subset module 41₂ operating on the same second virtual machine 21₂ (step S102). The SDK API 221B₂ passes, to the subset module 41₂, various parameters (hereinafter, screen page generation information), including application identification information specified by the SDK application 222B₂ with the generation request.

When an application screen page generation request is received, the subset module 41₂ uses the communications unit 51₂ to perform inter-virtual machine communications with the subset module 41₁ operating on the first virtual machine 21₁, to transfer the process of generating an application screen page to the first virtual machine 21₁ (step S103). The subset module 41₂ uses the transmitting unit 511₂ of the communications unit 51₂ to convert the screen page generation information into a value that can be specified by the screen control module 42 for performing the process of generating an application screen page, and sends the value to the first virtual machine 21₁. Accordingly, the second virtual machine 21₂ makes the request for a process to generate an application screen page. As a result, the subset module 41₁ receives, with the receiving unit 512₁ of the communications unit 51₁, screen page generation information obtained as a result of the conversion (post-conversion screen page generation information), which is sent from the subset module 41₂ operating on the second virtual machine 21₂. Thus, the first virtual machine 21₁ receives the application screen page generation request.

When the subset module 41₁ receives the application screen page generation request, the receiving unit 512₁ of the communications unit 51₁ sends a request to render an application screen page to the process request unit 52₁ (step S201). The receiving unit 512₁ passes, to the process request unit 52₁, the post-conversion screen page generation information accompanying the generation request.

The process request unit 52₁ requests the screen control module 42 to execute an application screen page generating process (to render an application screen page) based on the post-conversion screen page generation information (step S202). The process request unit 52₁ sets various post-conversion parameters including the application identification information (screen page generation information) as execution parameters for the screen control module 42 and requests the screen control module 42 to execute the application screen page generating process.

Based on the set parameters, the screen control module 42 executes a process of generating an application screen page (rendering an application screen page) on the display screen page of the display device 120 provided in the image processing apparatus 100 (step S203). In the application screen page generation process, when image data is used for the display element P forming the application screen page, the screen control module 42 accesses the image resource 31 and acquires the image data based on the application identification information.

In the display device 120, the application screen page is rendered as described above (step S204). The display device 120 returns the execution result of the application screen page generation process to the process request unit 52₁ via the screen control module 42.

As described above, in the image processing apparatus 100, inter-virtual machine communications are performed with the use of the subset modules 41 for transferring, to the first virtual machine 21₁, the application screen page generation process of the SDK application 222B₂ operating on the second virtual machine 21₂, and for generating the display screen page.

(Process 2—First Embodiment)

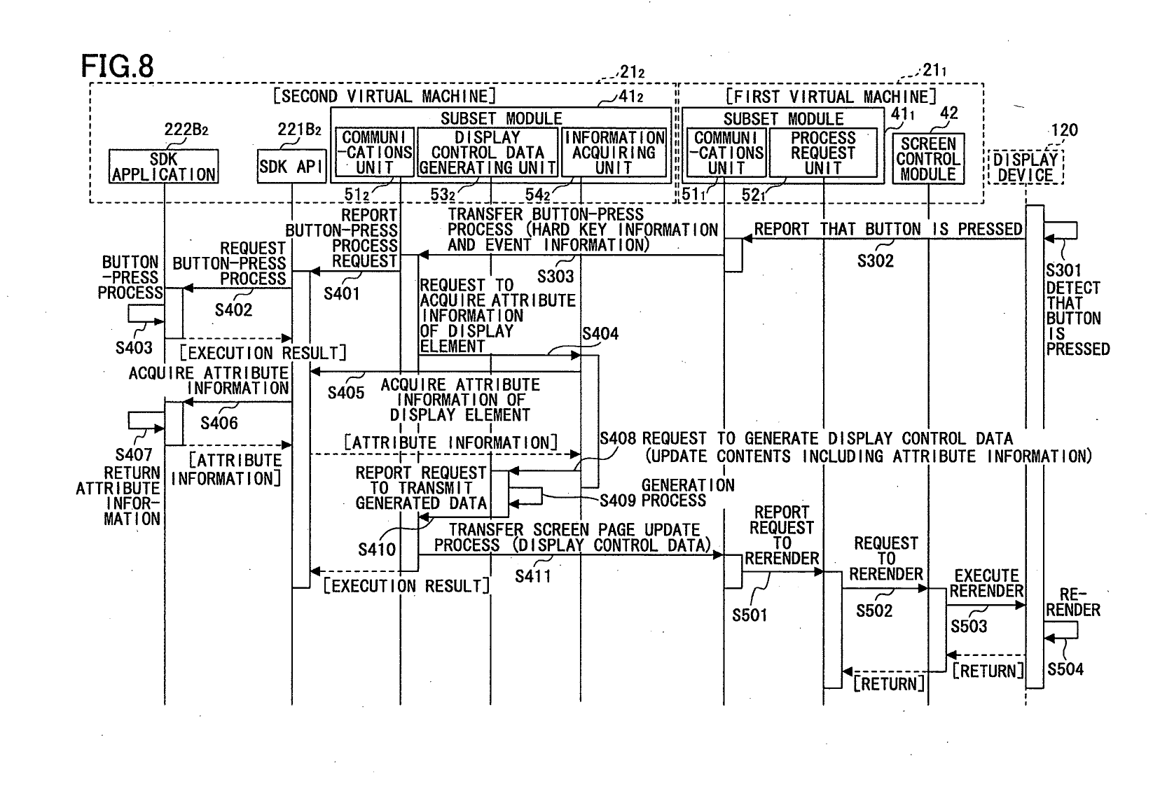

FIG. 8 is a sequence diagram of processing procedures (process 2) for performing display control according to the present embodiment.

As shown in FIG. 8, in the image processing apparatus 100, the following display control process is executed to update an application screen page of the SDK application 222B₂ when a button is pressed.

At the display device 120, it is detected that a hard key button has been pressed (step S301). The detection signal indicating that the button has been pressed is passed to the hard key event distribution module 43 (see FIG. 3) operating on the first virtual machine 21₁, and a hard key event is reported from the hard key event distribution module 43 to the subset module 41₁ (step S302). The hard key event distribution module 43 issues hard key information and operation event information based on the detection signal, and sends the information to the subset module 41₁. The subset module 41₁ receives the information as an event report, with the use of the communications unit 51₁.

When the subset module 41₁ receives the event report, the communications unit 51₁ performs inter-virtual machine communications with the subset module 41₂ operating on the second virtual machine 21₂, to transfer the process that is performed when the button is pressed (button-press process) to the second virtual machine 21₂ (step S303). The subset module 41₁ sends the hard key information and operation event information to the second virtual machine 21₂, with the use of the transmitting unit 511₁ (see FIG. 4) of the communications unit 51₁. Accordingly, the first virtual machine 21₁ makes the request for a process performed when a button is pressed (button-press process request). As a result, the subset module 41₂ receives, with the receiving unit 512₂ (see FIG. 4) of the communications unit 51₂, hard key information and operation event information, which have been sent from the subset module 41₁ operating on the first virtual machine 21₁. Thus, the second virtual machine 21₂ receives the button-press process request.

When the subset module 41₂ receives the button-press process request, the receiving unit 512₂ of the communications unit 51₂ reports the button-press process request to the SDK API 221B₂ (step S401). The receiving unit 512₂ passes, to the SDK API 221B₂, the hard key information and operation event information accompanying the process request.

The SDK API 221B₂ requests the SDK application 222B₂ to execute the button-press process (step S402). The SDK API 221B₂ passes the hard key information and operation event information to the SDK application 2223₂, and requests the SDK application 222B₂ to execute the button-press process.

The SDK application 222B₂ executes the button-press process (step S403). Furthermore, the

SDK application 222B₂ returns the execution result of the button-press process to the SDK API 221B₂.

When the subset module 41₂ receives the button-press process request, the receiving unit 512₂ of the communications unit 51₂ requests the information acquiring unit 54₂ to acquire attribute information relevant to the display element P that forms the application screen page after the screen page is updated due to the button-press (step S404).

When the request to acquire attribute information is received, the information acquiring unit 54₂ acquires attribute information relevant to the display element P from the SDK application 222B₂ via the SDK API 221B₂ (steps S405 to S407).

The information acquiring unit 54₂ requests the display control data generating unit 53₂ of the subset module 41₂ to generate the display control data 60 when updating the screen page (step S408). The information acquiring unit 54₂ passes the acquired attribute information to the display control data generating unit 53₂ and requests the display control data generating unit 53₂ to generate the display control data 60.

When the data generation request is received, the display control data generating unit 53₂ generates the display control data 60 based on the attribute information relevant to the display element P and contents of the operation for updating the screen page (step S409). The display control data generating unit 53₂ determines a display control command according to the contents of the operation for updating the screen page, and specifies a display element identifier of the display element P that is the control target. When “add” or “change” is specified as the display control when updating the screen page, the display control data generating unit 53₂ adds, to the display control command, the contents of the display element P that is a control target, based on attribute information of the display element P.

The display control data generating unit 53₂ sends a request to transmit the generated display control data 60 to the subset module 41₂ operating on the same second virtual machine 21₂ (step S410). The display control data generating unit 53₂ passes the generated display control data 60 to the subset module 41₂.

When the request to transmit the display control data 60 is received, the subset module 41₂ uses the communications unit 51₂ to perform inter-virtual machine communications with the subset module 41₁ operating on the first virtual machine 21₁, and transfers the application screen page update process to the first virtual machine 21₁ (step S411). The subset module 41₂ uses the transmitting unit 511₂ of the communications unit 51₂ to send the display control data 60 to the subset module 41₁. Accordingly, the second virtual machine 21₂ makes the request for a process to update the application screen page. As a result, the subset module 41₁ receives, with the receiving unit 512₁ of the communications unit 51₁, the display control data 60 that is sent from the subset module 41₂ operating on the second virtual machine 21₂. Accordingly, the first virtual machine 21₁ receives the request to update the application screen page.

When the subset module 41₁ receives the application screen page update request, the receiving unit 512₁ of the communications unit 51₁ sends a request to render an application screen page to the process request unit 52₁ (step S501). The receiving unit 512₁ passes, to the process request unit 52₁, the display control data 60 accompanying the update request.

The process request unit 52₁ requests the screen control module 42 to execute the application screen page update process (once again render (rerender) the application screen page), based on the display control data 60 (step S501). The process request unit 52₁ sets the execution parameter of the screen control module 42 based on the data analysis result of the display control data 60 and requests the screen control module 42 to execute the application screen page update process.

The screen control module 42 executes the application screen page update process (rerender the application screen page) on the display screen page of the display device 120 in the image processing apparatus 100, based on the set parameters (step S503).

In the display device 120, the application screen page is rerendered and updated (step S504). The display device 120 returns the execution result of the application screen page update process to the process request unit 52₁ via the screen control module 42.

As described above, in the image processing apparatus 100, inter-virtual machine communications are performed with the use of the subset modules 41 to transfer the application screen page update process of the SDK application 222B₂ operating on the second virtual machine 21₂ to the first virtual machine 21₁, to update the display screen page.

<Overview>

As described above, in the image processing apparatus 100 according to the present embodiment, the second virtual machine 21₂ acquires attribute information of the display element P that forms the display screen page according to the screen page update request, and generates the display control data 60 with the use of a unique command for display control (display control command) based on the acquired attribute information. The image processing apparatus 100 sends the generated display control data 60 to the first virtual machine 21₁ on which the screen control module 42 for controlling the display screen page is operating. As a result, in the image processing apparatus 100, the first virtual machine 21₁ executes the screen control module 42 and performs display control according to the received data.

Accordingly, in the image processing apparatus 100, the amount of data transmitted between the virtual machines for display control can be reduced. As a result, information provided to the user and the GUI can be displayed at high speed (the process of displaying a screen page can be accelerated).

### Second Embodiment

In a second embodiment according to the present invention, a servlet is used as the screen page display module for controlling the display screen page. Accordingly, similar to the first embodiment, the amount of data transmitted between virtual machines for display control can be reduced. In a description of the present embodiment, elements corresponding to those of the first embodiment are denoted by the same reference numerals and are not further described. <Software Configuration>

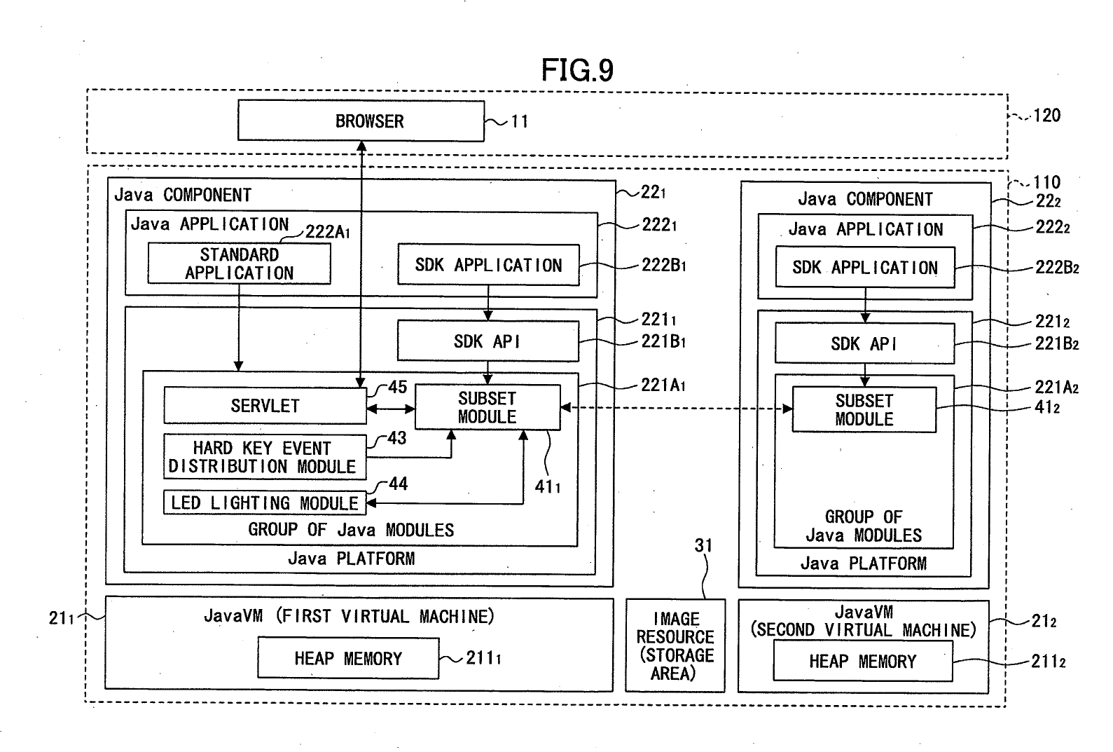

FIG. 9 illustrates a software configuration of a system with plural virtual machines.21, according to the second embodiment of the present invention.

As shown in FIG. 9, in the present embodiment, a servlet 45 is used as the screen control module 42. The servlet 45 is a program (Java class) that dynamically generates Web contents such as an HTML document. The servlet 45 operates on the Web server, and dynamically generates Web contents in response to an HTTP request from the browser 11.

As described above, in the present embodiment, the servlet 45 provides a display screen page via the browser 11. Specifically, in a platform for providing an interface for creating a GUI of Java in a format compatible with AWT (Abstract Windowing Tools), the display element P is converted into an HTML format and displayed on the browser 11, without using an Applet. The AWT is a name of a class library used for implementing a GUI with Java.

The following benefits can be achieved by using the browser 11 for providing a display screen page.

For example, in the display control data 60 of the first embodiment, HTML data is used as detailed information relevant to the display element P. In the conventional method of rendering a display screen page in the AWT format, the instance (actual value) of the display element P in the AWT format needs to be copied to the first virtual machine 21₁ that renders the screen page, and therefore the data used for displaying a screen page becomes redundant. Furthermore, the data exchanged between virtual machines is an object in the AWT format, and therefore the amount of transmitted data increases.

Conversely, the browser 11 uses HTML data as the data relevant to screen page display, and therefore the amount of data used for displaying a screen page can be reduced.

Furthermore, in recent years and continuing, Ajax (Asynchronous JavaScript+XML) is known as a technology used for the browser 11. Ajax is a technology for building an interface for asynchronous communications in the browser 11. Specifically, asynchronous communications (message exchange) are performed with an XML HTTP Request. Therefore, by using Ajax, the display control data 60 can be asynchronously exchanged between virtual machines with the browser 11. Accordingly, only part of the display screen page needs to be updated in the display control process. As a result, the screen page can be displayed at higher speed.

Furthermore, in the present embodiment, with the above-described software configuration, the display control process, which is performed when a button is pressed on the display screen page (process of updating button image), can be implemented with a JavaScript operating on the browser 11. That is to say, in the display control process when a button is pressed, communications do not need to be performed between virtual machines. As a result, the frequency of communications performed for display control can be reduced.

Specifically, the following describes a case where buttons are laid out on the application screen page of the SDK application 222B₂ operating on the second virtual machine 21₂.

When the SDK application 222B₂ makes a request for generating an application screen page, the second virtual machine 21₂ sends, to the first virtual machine 21₁, display control data for making the request for generating the screen page, via the subset module 41₂. The subset module 41₁ operating on the first virtual machine 21₁ receives the display control data, and displays the application screen page based on the received data on the browser 11 via the servlet 45.

Therefore, in the present embodiment, a JavaScript program including the following information is sent together with HTML data, as the display control data sent from the second virtual machine 21₂ to the first virtual machine 21₁.
procedure of rendering button image when curser is not on button
procedure of rendering button image when curser is on button
procedure of rendering button image when button is pressed
procedure of reporting event to servlet 45 when button is pressed

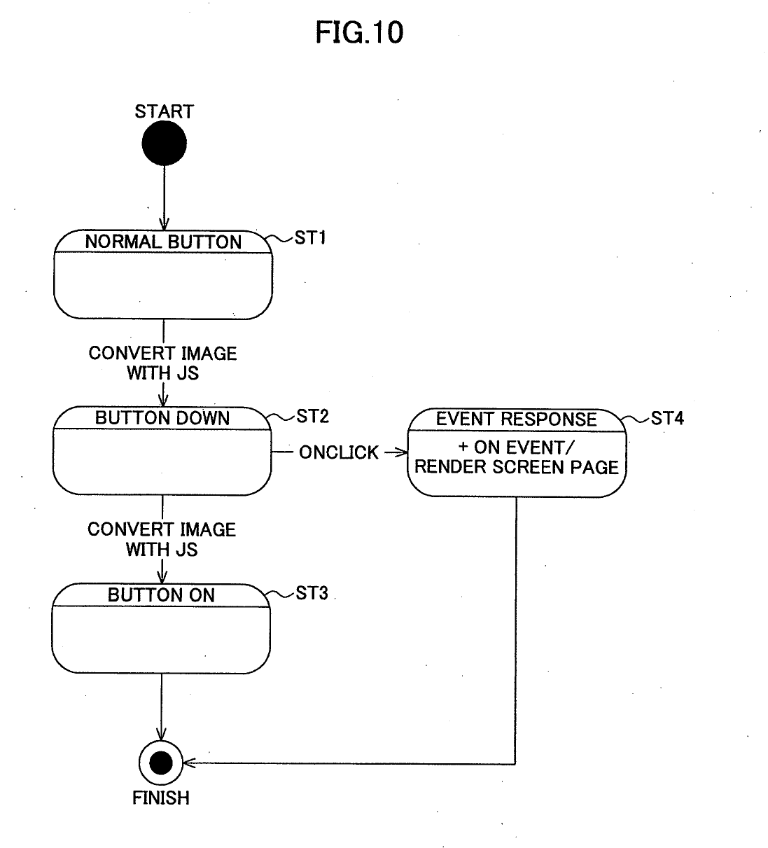

FIG. 10 illustrates the state transition of a button image according to the present embodiment.

As shown in FIG. 10, “normal Button” is a state where the curser is not on the button (ST1). “Button down” is a state where the curser is on the button (ST2). “Button on” is a state where the button is pressed (ST3). In the state transition from ST1 to ST3, the JavaScript program (rendering procedure) is performed to change the button image. Furthermore, “event response” is a state where the button is pressed (ST4). In the state transition from ST2 to ST4, Java script is used to change the button image and report an event (ON event) to the servlet 45. As described with reference to FIG. 10, a command to render a screen page is given to the servlet 45 when transition of the screen page occurs as a button is pressed. However, the present invention is not so limited. A button image may be updated without sending a command such as an HTML data request to the servlet 45.

<Display Control Function>

A description is given of the display control function according to the present embodiment.

The display control function of the image processing apparatus 100 according to the present embodiment is implemented as the subset module 41 operates on the virtual machine 21, which is described in the first embodiment. Thus, details of the function configuration are not further described. However, a description is given of detailed operations of the display control function (coordination operation of function unit groups), with reference to a sequence diagram indicating the processing procedures.

The display control function, which is implemented as a display control program installed in the image processing apparatus 100, is loaded into the RAM from a storage (for example, a ROM) by the CPU 111, and the following process is executed. In the following, a process 1 of generating an application screen page of the SDK application 222B₂ operating on the second virtual machine 21₂, and a process 2 of updating the application screen page of the SDK application 2228₂ when a button is pressed, are described as examples of the display control process.

(Process 1—Second Embodiment)

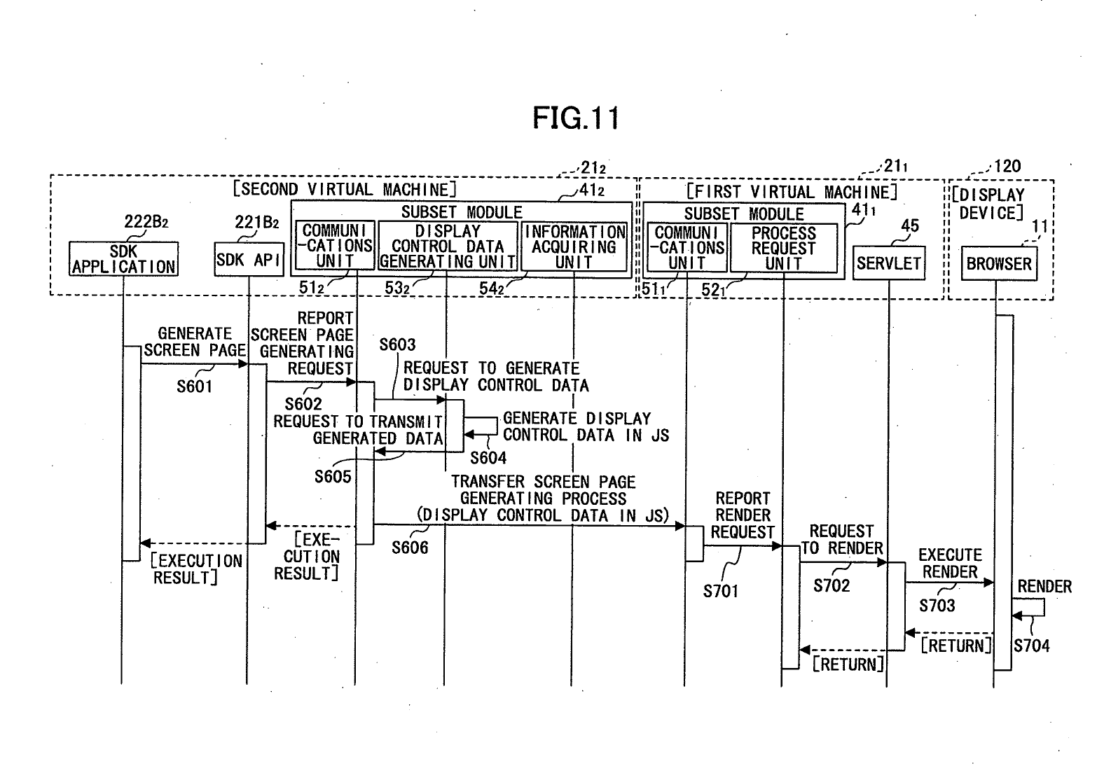

FIG. 11 is a sequence diagram of processing procedures (part 1) for implementing display control according to the present embodiment.

As shown in FIG. 11, in the image processing apparatus 100, when generating an application screen page of the SDK application 222B₂ operating on the second virtual machine 21₂, the following display control process is executed.

The SDK application 222B₂ operating on the second virtual machine 21₂ uses the SDK API 221B₂ to generate an application screen page (step S601).

The SDK API 221B₂ sends an application screen page generation request to the subset module 41₂ operating on the same second virtual machine 21₂ (step S602). The SDK API 221B₂ passes, to the subset module 41₂, attribute information relevant to the display element P for forming the application screen page, whereby the attribute information has been received from the SDK application 222B₂ accompanying the generation request.

When the application screen page generation request is received at the subset module 41₂, the communications unit 51₂ requests the display control data generating unit 53₂ of the subset module 41₂ to generate the display control data 60 for generating the screen page (step S603). The communications unit 51₂ passes the attribute information that has been received to the display control data generating unit 53₂ to request the display control data generating unit 53₂ to generate the display control data 60.

When the request to generate data is received, the display control data generating unit 53₂ generates the display control data 60 based on the attribute information relevant to the display element P and screen page generation contents (step S604). The display control data generating unit 53₂ generates HTML data for defining the layout of the display screen page as the display control data 60. The HTML data includes a JavaScript program for executing a display control process.

A description is given of the display control data 60 generated by the display control data generating unit 53₂ according to the present embodiment. As described above, Ajax is used in the present embodiment. Therefore, the display control data generating unit 53₂ generates the display control data 60 with the use of DOM (Document Object Model). DOM is an API that uses applications to use HTML documents and XML (Extensible Markup Language) documents that are recommended by the W3C (World Wide Web Consortium). The display control data generating unit 53₂ uses the DOM to generate and update the display control data 60 (HTML data) (generate, add, or delete a display element P for forming the display screen page).

For example, when generating a display element P, the display control data generating unit 53₂ generates the display control data 60 as an object on the DOM, by document.createElement( ) Furthermore, the display control data generating unit 53₂ adds a display element P by appendChild( ), and deletes (removes) a display element P by removeChild( ). The display control data generating unit 53₂ generates and updates the display control data 60 in the above-described manner.

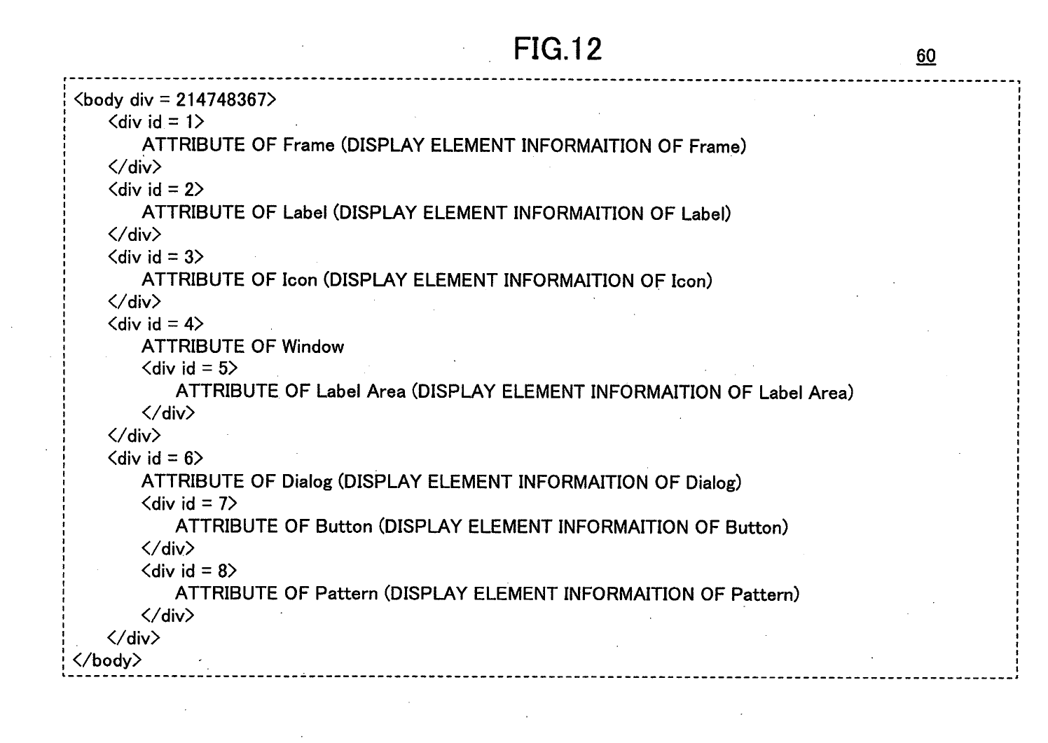

FIG. 12 illustrates an example of a data structure for display control according to the present embodiment. In FIG. 12, DIV tags in an HTML format are used to indicate data for defining display elements P for forming the display screen page. In the display control data 60, each display element P can be defined by one set of DIV tags, and corresponds to an object on DOM. In the display control data 60, DIV tags are described in accordance with the hierarchical structure (parent-child relationship) of the display elements P.

A DIV tag defines the display element identifier (ID) for identifying the display element.

In the display control data 60, the display element P that is a target of control on the display screen page can be identified by the display element identifier.

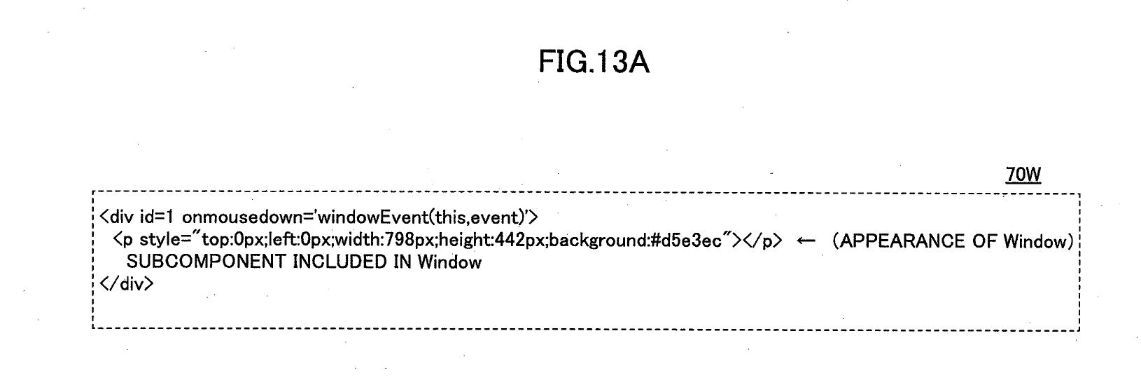

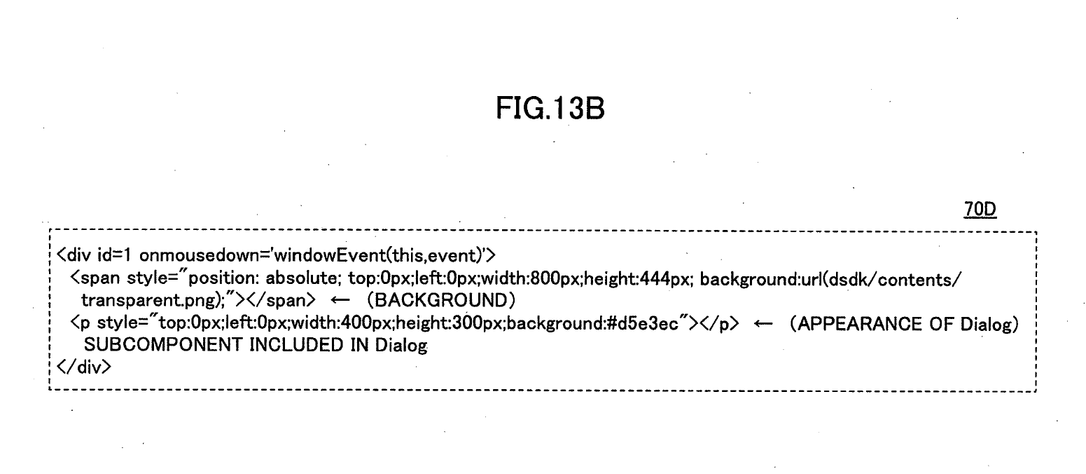

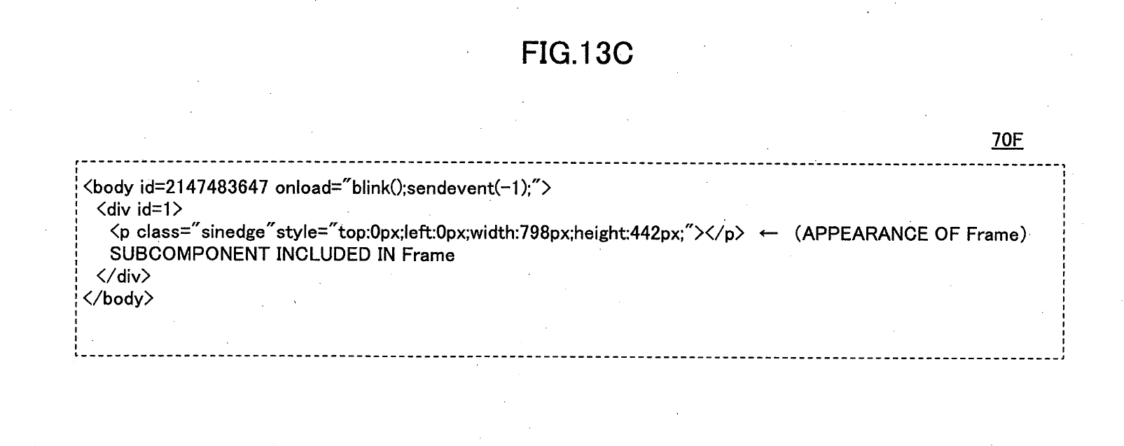

A DIV tag can define information (display element information) including attributes of the display element P, as illustrated in FIGS. 13A through 15C. The display element information includes the location (coordinates) of disposing the display element P, the appearance of the display element P (for example, color, size, and added characters), and the storage destination (for example, a path of the image resource 31).

FIGS. 13A through 15C illustrate examples of data (part 1 through part 3) of the display element information according to the present embodiment.

FIG. 13A illustrates an example of data of display element information 70W of a display element window P4. The display element information 70W defines the appearance of the window. FIG. 13B illustrates an example of data of display element information 70D of a display element dialog P6. The display element information 70D defines the background color and the appearance of the dialog. FIG. 13C illustrates an example of data of display element information 70F of a display element frame P1. The display element information 70F defines the appearance of the frame.

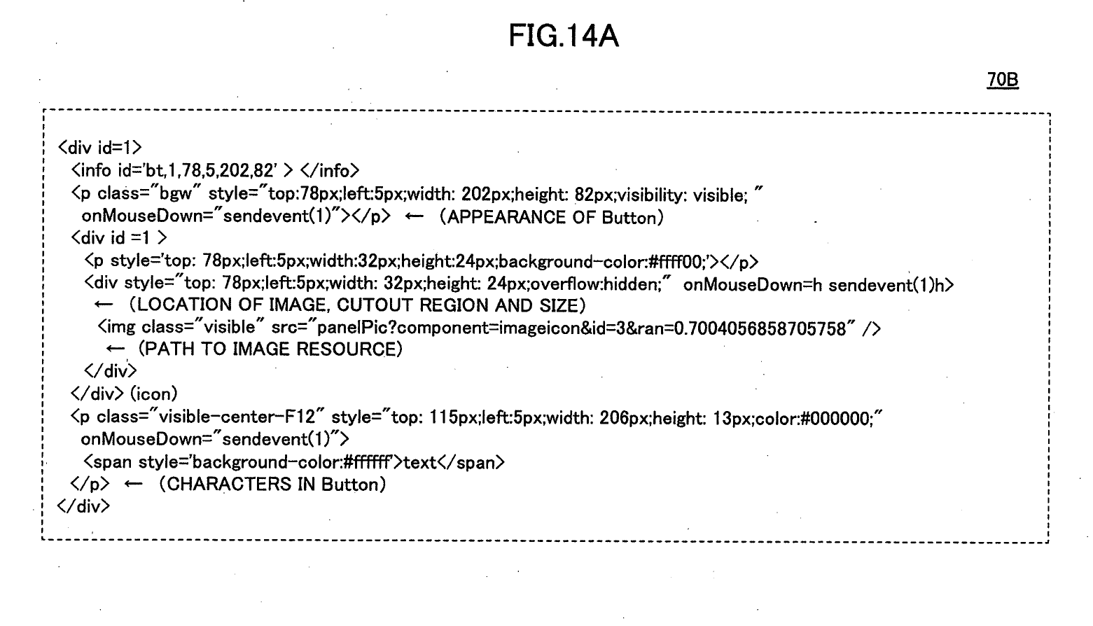

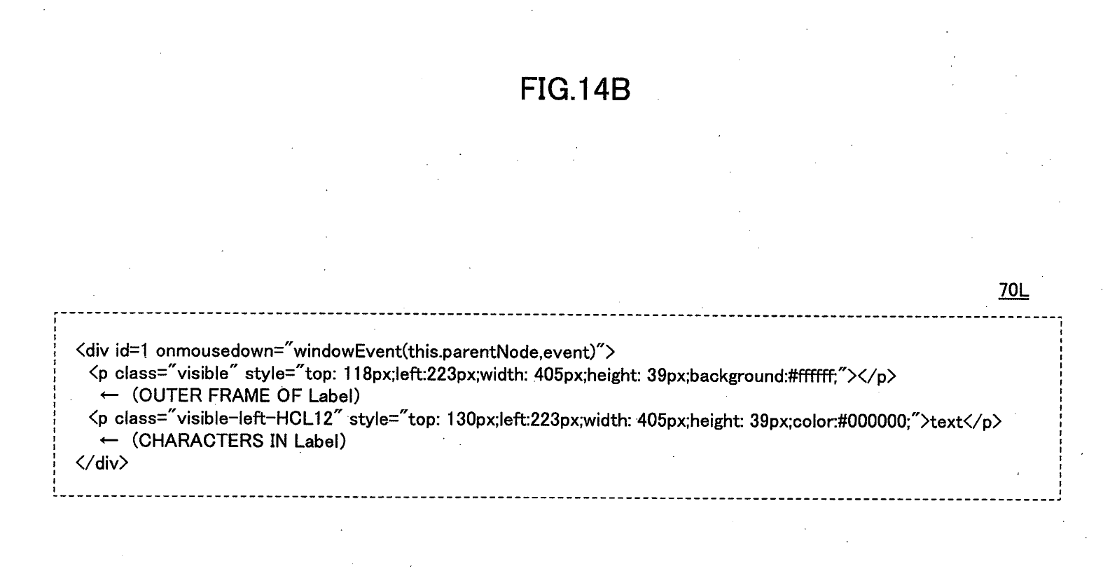

FIG. 14A illustrates an example of data of display element information 70B of a display element button P7. The display element information 70B defines the appearance of a button, a location where the button image is disposed, the cutout region and size, the storage destination of the button image, and characters in the button. FIG. 14B illustrates an example of data of display element information 70L of a display element label P2. The display element information 70L defines the outer frame of a label and characters in the label.

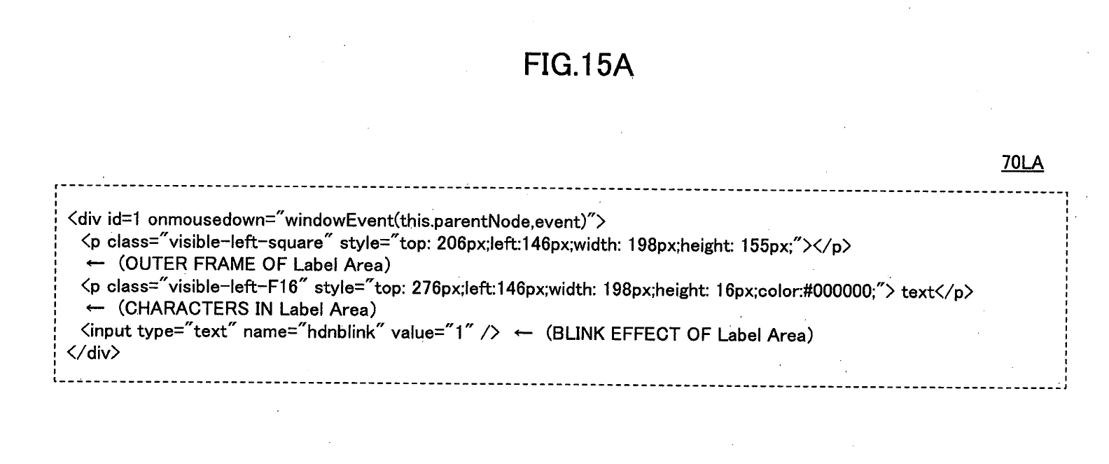

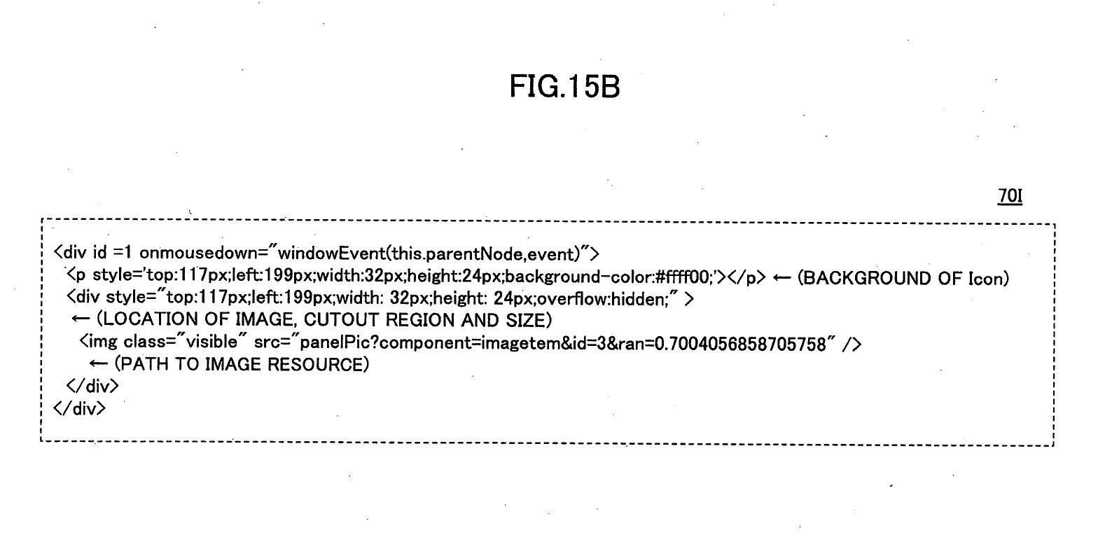

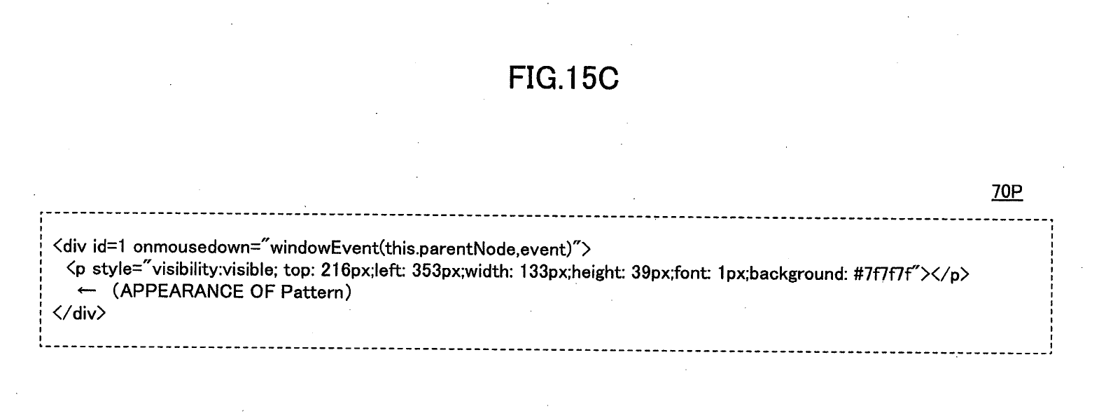

FIG. 15A illustrates an example of data of display element information 70LA of a display element label area P5. The display element information 70LA defines the outer frame of a label area and characters in the label area. FIG. 15B illustrates an example of data of display element information 70I of a display element icon P3. The display element information 70I defines the background of an icon, a location where the icon is disposed, the cutout region and size, and the storage destination of the icon image. FIG. 15C illustrates an example of data of display element information 70P of a display element pattern P8.

The display control data generating unit 53₂ generates the display control data 60 in an HTML format including the above DIV tags, with the use of a common interface for implementing the process of generating the display elements P. Therefore, the display control data generating unit 53₂ can execute a generating process common to different types of display elements P. In the process of generating different types of display elements P that are to be laid out in the display screen page, the display control data 60 can be generated in accordance with the hierarchical structure (parent-child relationship) by recursively calling the common interface.

The description of the processing procedures of display control is continued below.

The display control data generating unit 53₂ sends, to the subset module 41₂ operating on the same second virtual machine 21₂, a request to transmit the generated display control data 60 (step S605). The display control data generating unit 53₂ passes the generated display control data 60 to the subset module 41₂.

When the request to transmit the display control data is received, the subset module 41₂ uses the communications unit 51₂ to perform inter-virtual machine communications with the subset module 41₁ operating on the first virtual machine 21₁, to transfer the process of generating an application screen page to the first virtual machine 21₁ (step S606). The subset module 41₂ uses the transmitting unit 511₂ (see FIG. 4) of the communications unit 51₂ to transmit the display control data 60. Accordingly, the second virtual machine 21₂ makes the request for a process to generate the application screen page. As a result, the subset module 41₁ receives, with the receiving unit 512₁ (see FIG. 4) of the communications unit 51₁, the display control data 60, which is sent from the subset module 41₂ operating on the second virtual machine 21₂. Thus, the first virtual machine 21₁ receives the application screen page generation request.

When the subset module 41₁ receives the application screen page generation request, the receiving unit 512₁ of the communications unit 51₁ sends a request to render an application screen page to the process request unit 52₁ (step S701). The receiving unit 512₁ passes, to the process request unit 52₁, the display control data 60 accompanying the update request.

The process request unit 52₁ requests the servlet 45 to execute a process of generating an application screen page based on the display control data 60 (to render the application screen page) (step S702). The process request unit 52₁ passes the display control data 60 to the servlet 45 and requests the servlet 45 to execute a process of generating the application screen page.

According to the received display control data 60, the servlet 45 executes a process of generating the application screen page (to render the application screen page) on the browser 11 operating on the display device 120 provided in the image processing apparatus 100 (step S703).

In the display device 120, an application screen page is rendered and generated in the browser (step S704). The display device 120 returns the execution result of the application screen page generation process performed by the browser 11, to the process request unit 52₁ via the servlet 45.

As described above, in the image processing apparatus 100, inter-virtual machine communications are performed with the use of the subset modules 41 for transferring, to the first virtual machine 21₁, the application screen page generation process of the SDK application 222B₂ operating on the second virtual machine 21₂, and for generating the display screen page.

(Process 2—Second Embodiment)

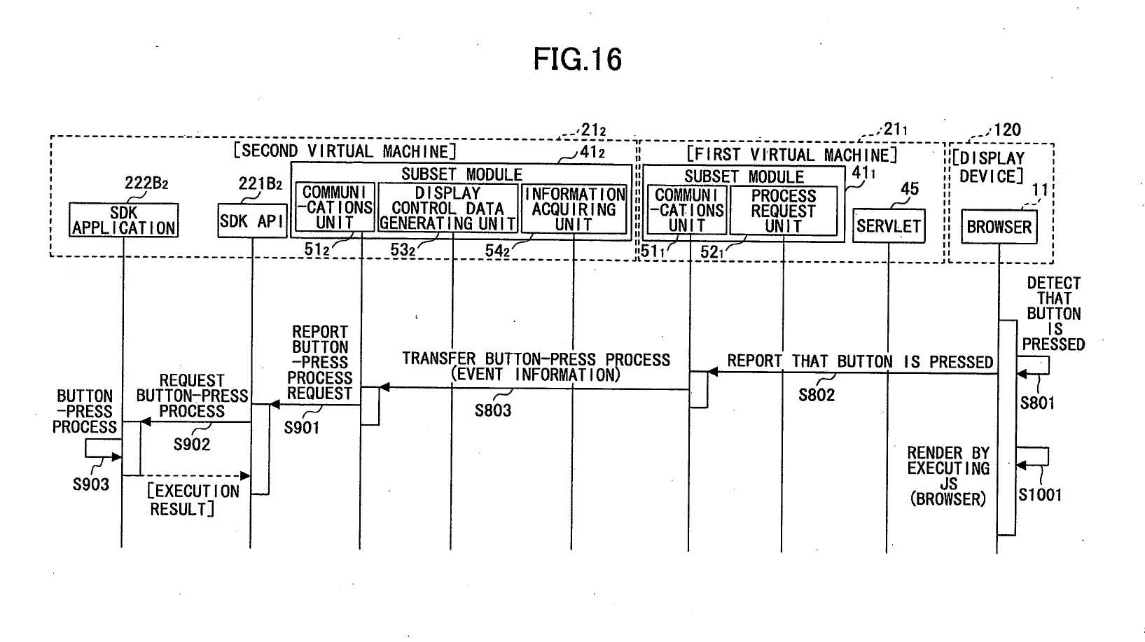

FIG. 16 is a sequence diagram of processing procedures (process 2) for implementing display control according to the present embodiment. As shown in FIG. 16, in the image processing apparatus 100, the following display control process is executed to update an application screen page of the SDK application 222B₂ when a button is pressed.

At the display device 120, it is detected that a hard key button has been pressed (step S801). The detection signal indicating that the button has been pressed is passed to the hard key event distribution module 43 (see FIG. 3) operating on the first virtual machine 21₁, and a hard key event is reported from the hard key event distribution module 43 to the subset module 41₁ (step S802). The hard key event distribution module 43 issues hard key information and operation event information based on the detection signal, and sends the information to the subset module 41₁. The subset module 41₁ receives the information as an event report, with the use of the communications unit 51₁.

When a button of a GUI is pressed on the browser 11 operating on the display device 120, the operation event is reported to the subset module 41₁ via the servlet 45.

When the subset module 41₁ receives the event report, the communications unit 51₁ performs inter-virtual machine communications with the subset module 41₂ operating on the second virtual machine 21₂, to transfer the process when the button is pressed (button-press process) to the second virtual machine 21₂ (step S803). The subset module 41₁ sends the hard key information and operation event information to the second virtual machine 21₂, with the use of the transmitting unit 511₁ (see FIG. 4) of the communications unit 51₁. Accordingly, the first virtual machine 21₁ makes the request for a process performed when a button is pressed (button-press process request). As a result, the subset module 41₂ receives, with the receiving unit 512₂ (see FIG. 4) of the communications unit 51₂, hard key information and operation event information, which have been sent from the subset module 41₁ operating on the first virtual machine 21₁. Thus, the second virtual machine 21₂ receives the button-press process request.

When the subset module 41₂ receives the button-press process request, the receiving unit 512₂ of the communications unit 51₂ sends the button-press process request to the SDK API 221B₂ (step S901). The receiving unit 512₂ passes, to the SDK API 221B₂, the hard key information and operation event information accompanying the process request.

The SDK API 221B₂ requests the SDK application 222B₂ to execute the button-press process (step S902). The SDK API 221B₂ passes the hard key information and operation event information to the SDK application 222B₂, and requests the SDK application 222B₂ to execute the button-press process. The SDK application 222B₂ executes the button-press process (step S903). Furthermore, the SDK application 222B₂ returns the execution result of the button-press process to the SDK API 221B₂.

In the display device 120, a JavaScript program is executed on the browser 11 in an asynchronous manner with respect to the process of steps 5901 through S903 executed in the second virtual machine 21₂, to perform the process of updating the application screen page (rerendering the application screen page) when a button is pressed. This process corresponds to step S1001.

In the browser 11, the application screen page is displayed in accordance with the display control data 60 in the HTML format received with the screen page generation request. Furthermore, a JavaScript program is received together with the HTML data with the screen page generation request.

Accordingly, in the browser 11, the JavaScript program is executed and the application screen page is updated when a button is pressed on the GUI. An update process according to the state transition is performed on the display elements P corresponding to the received operation event.

A detailed description is given below. In the browser 11, the display element information 70 corresponding to the update target is identified from the display control data 60, based on the display element identifier of the display element P that has been pressed. The browser 11 updates the identified display element information 70, i.e., the data defined with the DIV tag. As described above, the display control data 60 is generated as a DOM object, and the display element information 70 in the display control data 60 is generated or updated with the use of DOM. Therefore, in the browser 11, the corresponding data is updated with the use of DOM, and the process of updating the application screen page (rerendering the application screen page) is executed. In the display device 120, the application screen page is rerendered and updated in the above manner.

As described above, in the image processing apparatus 100, inter-virtual machine communications are performed with the use of the subset modules 41, in order to transfer the application screen page update process from the SDK application 222B₂ operating on the second virtual machine 21₂ to the first virtual machine 21₁, and to update the display screen page.

<Modification>

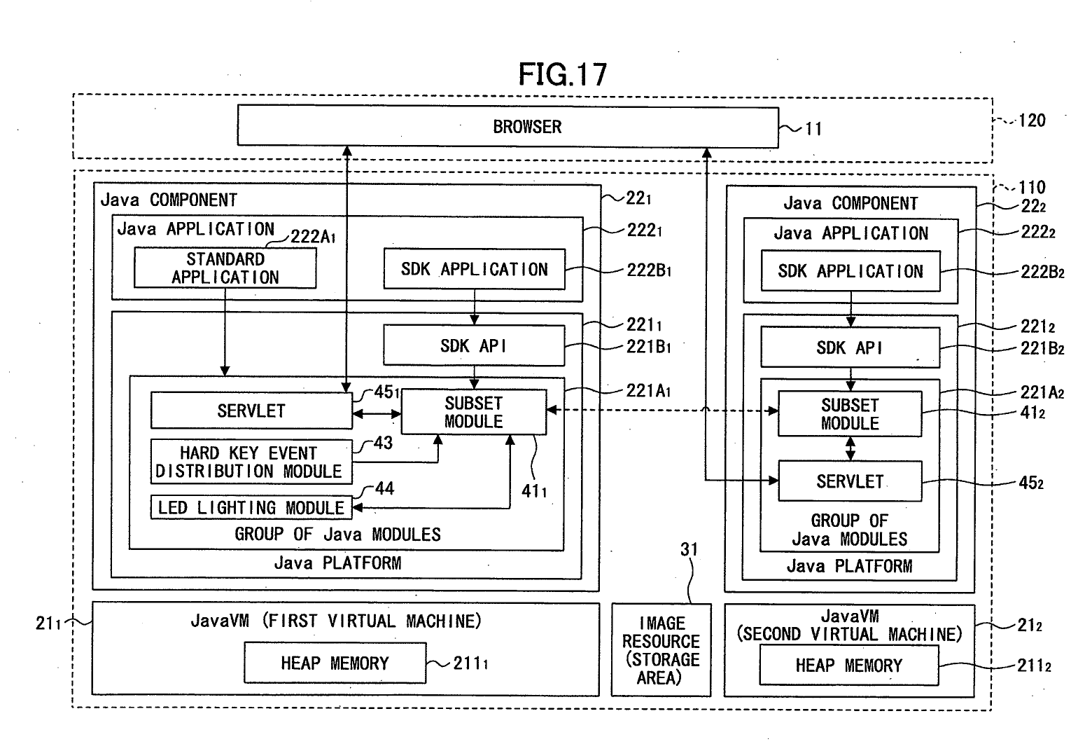

FIG. 17 illustrates a software configuration of a system with plural virtual machines, according to a modification of the second embodiment.

As shown in FIG. 9, in the second embodiment, the servlet 45 is only operated in the first virtual machine 21₁; however, the present invention is not so limited.

For example, as shown in FIG. 17, the servlet 45 may operate in the second virtual machine 21₂ as well.

With the software configuration according to the modification, the frequency of inter-virtual machine communications can be further reduced compared to the configuration in which the servlet 45 inter-virtual machine communications may be performed with the use of the subset modules 41 when distributing hard key events and controlling lighting of the LED. However, when a display screen page is generated or updated, there is no need to perform inter-virtual machine communications. This is because all of the above-described processes of generating/updating a display screen page can be completed as a function that is implemented by the browser 11 and the servlet 45. In order to operate the servlets 45 in both the first virtual machine 21₁ and the second virtual machine 21₂, it is preferable to determine port numbers used for HTTP (HyperText Transfer Protocol) communications and URLs (Uniform Resource Locator) registered in the servlets 45, so as not to cause competition between the two servlets 45. That is to say, the web server operating in the first virtual machine 21₁ and the web server operating in the second virtual machine 21₂ are to have different port numbers and URLs for use in the browser 11.

<Overview>

As described above, with the image processing apparatus 100 according to the present embodiment, the display control data 60 is generated. The display control data 60 includes detailed information (display element information) including attributes of display elements P forming the display screen page, and a program (procedure) for generating/updating the display element P according to a request. The image processing apparatus 100 sends the generated display control data 60 to the first virtual machine 21₁ in which the servlet 45 for controlling the display screen page is operating. As a result, the image processing apparatus 100 can process the display control data 60 with the use of the servlet 45 in the first virtual machine 21₁, and implement display control such as generating/updating the display screen page with the browser operating in the display device 120.

Accordingly, when display control is performed in the image processing apparatus 100, the data amount communicated between virtual machines and the frequency of inter-virtual machine communications can be reduced. As a result, information and GUIs can be displayed to the user at high speed (the speed of displaying screen pages can be increased).

Furthermore, in the present embodiment, the processes of generating/updating a display screen page are implemented by the browser 11 and the servlet 45, and therefore stable operations can be achieved in an environment including plural virtual machines.

The display control function of the image processing apparatus 100 according to the present embodiment is implemented as the CPU 111 executes a program that is encoded in a programming language that is appropriate for the environment (platform) for operating the processing procedures that are described above with reference to various figures.

Such a program may be stored in the computer-readable recording medium 114A. Examples of the recording medium 114A are an SD memory card and a USB memory.

Accordingly, by storing the above program in the recording medium 114A, the program can be installed in the image processing apparatus 100 via the external storage I/F 114 that can read the recording medium 114A. Furthermore, the image processing apparatus 100 includes the network I/F 113, and therefore the program can be downloaded and installed in the image processing apparatus 100 with the use of an electric communications line such as the Internet.

The present invention is not limited to the specific embodiments described herein, and variations and modifications may be made without departing from the scope of the present invention.

The present application is based on Japanese Priority Patent Application No. 2009-163074, filed on Jul. 9, 2009, the entire contents of which are hereby incorporated herein by reference.

What is claimed is:

1. An image processing apparatus comprising:
a first virtual machine in which a standard function of the image processing apparatus is operated;
a second virtual machine in which an extension function that uses the standard function is operated, the second virtual machine being different from the first virtual machine;
plural operation modules configured to implement display control on a display screen page as the standard function;
a first communications interface unit configured to operate in the first virtual machine; and
a second communications interface unit configured to operate in the second virtual machine, wherein
the first communications interface unit and the second communications interface unit perform inter-virtual machine communication that is common to the plural operation modules,
the second communications interface unit includes
a generating unit configured to generate display control data with the use of a display control command in response to a screen page update request from an application that implements the extension function, the display control data being used for performing the display control on the display screen page of the application, and
a data transmitting unit configured to transmit the display control data generated by the generating unit to the first virtual machine in which the standard function is operated, and
the first communications interface unit includes
a data receiving unit configured to receive the display control data from the second virtual machine, and
a requesting unit configured to send, to a screen page control module configured to perform screen page control included among the plural operation modules, a request to perform the display control in accordance with the display control data received by the data receiving unit.

2. The image processing apparatus according to claim 1, wherein
the second communications interface unit of the second virtual machine further includes
an acquiring unit configured to acquire, from the application, attribute information relevant to a display element that forms the display screen page in accordance with the screen page update request, wherein
the generating unit generates the display control data with the use of the display control command, based on the attribute information relevant to the display element acquired by the acquiring unit.

3. The image processing apparatus according to claim 2, wherein
the generating unit generates the display control data including
the display control command for instructing the display control of deleting, adding, or changing the display element, and
a display element identifier specifying the display element that is a control target.

4. The image processing apparatus according to claim 3, wherein
the generating unit generates the display control data including the display element identifier specifying the display element that is the control target among plural display elements included in a hierarchical structure, in accordance with a parent-child relationship based on the hierarchical structure.

5. The image processing apparatus according to claim 3, wherein
when the display control command included in the display control data is for instructing the display control of deleting the display element, the screen page control module deletes at least one display element corresponding to a child of the display element that is the control target together with the display element that is the control target.

6. The image processing apparatus according to claim 1, wherein
the second communications interface unit of the second virtual machine further includes
a screen page generation information transmitting unit configured to transmit, to the first virtual machine, screen page generation information including application identification information for identifying the application, in response to a screen page generating request from the application, the screen page generation information being required for the screen page control module to generate the display screen page, and
the first communications interface unit of the first virtual machine further includes
a screen page generation information receiving unit configured to receive the screen page generation information from the first virtual machine.

7. The image processing apparatus according to claim 1, wherein
the first communications interface unit of the first virtual machine further includes
an event information transmitting unit configured to transmit, to the second virtual machine, event information indicating a button-press event received according to an input operation,
the second communications interface unit of the second virtual machine further includes
an event information receiving unit configured to receive the event information from the first virtual machine, and
the event information receiving unit requests the application to perform a process corresponding to the button-press event, based on the received event information.

8. The image processing apparatus according to claim 1, further comprising:
a display device in which a browser is operated; and
a servlet corresponding to the screen page control module, wherein
the requesting unit requests the servlet to execute the display control according to the display control data described in a JavaScript program received by the data receiving unit, and
the servlet renders the display screen page via the browser.

9. The image processing apparatus according to claim 7, further comprising:
a display device in which a browser is operated; and
a servlet corresponding to the screen page control module, wherein
the requesting unit requests the servlet to execute the display control according to the display control data described in a JavaScript program received by the data receiving unit, and
the servlet renders the display screen page via the browser.

10. The image processing apparatus according to claim 9, wherein
the event information transmitting unit transmits, to the second virtual machine, the event information indicating the button-press event according to the input operation received at the browser, and
the JavaScript program is executed at the browser to update the display screen page according to the button-press event.

11. A display control method performed in an image processing apparatus including
a first virtual machine in which a standard function of the image processing apparatus is operated,
a second virtual machine in which an extension function that uses the standard function is operated, the second virtual machine being different from the first virtual machine,
plural operation modules configured to implement display control on a display screen page as the standard function,
a first communications interface unit configured to operate in the first virtual machine, and
a second communications interface unit configured to operate in the second virtual machine, wherein
the first communications interface unit and the second communications interface unit perform inter-virtual machine communication that is common to the plural operation modules, the display control method comprising:
a generating step performed by the second communications interface unit to generate display control data with the use of a display control command in response to a screen page update request from an application that implements the extension function, the display control data being used for performing the display control on the display screen page of the application;
a data transmitting step performed by the second communications interface unit to transmit the display control data generated by the generating unit to the first virtual machine in which the standard function is operated;
a data receiving step performed by the first communications interface unit to receive the display control data from the second virtual machine; and
a requesting step performed by the first communications interface unit to send, to a screen page control module configured to perform screen page control included among the plural operation modules, a request to perform the display control in accordance with the display control data received by the data receiving unit.

12. A computer-readable recording medium having recorded therein instructions for causing a computer to function as an image processing apparatus including
a first virtual machine in which a standard function of the image processing apparatus is operated,
a second virtual machine in which an extension function that uses the standard function is operated, the second virtual machine being different from the first virtual machine,
plural operation modules configured to implement display control on a display screen page as the standard function,
a first communications interface unit configured to operate in the first virtual machine, and
a second communications interface unit configured to operate in the second virtual machine, wherein
the first communications interface unit and the second communications interface unit perform inter-virtual machine communication that is common to the plural operation modules, the instructions causing the image processing apparatus to execute:
a generating step performed by the second communications interface unit to generate display control data with the use of a display control command in response to a screen page update request from an application that implements the extension function, the display control data being used for performing the display control on the display screen page of the application;
a data transmitting step performed by the second communications interface unit to transmit the display control data generated by the generating unit to the first virtual machine in which the standard function is operated;
a data receiving step performed by the first communications interface unit to receive the display control data from the second virtual machine; and
a requesting step performed by the first communications interface unit to send, to a screen page control module configured to perform screen page control included among the plural operation modules, a request to perform the display control in accordance with the display control data received by the data receiving unit.
